(19) United States
(12) Patent Application Publication
(10) Pub. No.: US 2026/0348104 A1
(43) Pub. Date: Nov. 5, 2026

(54) ELECTROTHERMAL CEMENTITIOUS COMPOSITE WITH GRAPHENE NANOPLATELET-COATED AGGREGATES

(71) Applicant: Wayne State University, Detroit, MI (US)

(72) Inventors: Myrsini Maglogianni, Madison Heights, MI (US); Paul Akadini Abongo, Detroit, MI (US)

(21) Appl. No.: 19/665,324

(22) Filed: May 1, 2026

Related U.S. Application Data
(60) Provisional application No. 63/798,637, filed on May 2, 2025.

(51) Int. Cl. E01C 11/26; C04B 20/04; C04B 20/10; C04B 111/94; E01C 7/14

(52) U.S. Cl. CPC E01C 11/265; C04B 20/04; C04B 20/1055; C04B 20/1077; E01C 7/142; C04B 2111/94

(57) ABSTRACT

An electrically conductive and thermally responsive concrete manufactured using Type 1L Portland-limestone cement and aggregates pre-treated with graphene nanoplatelets (GNPs) at dosages of up to 0.4% by weight of cement is disclosed. The GNPs are pre-adsorbed onto the aggregate surfaces prior to mixing with cement, forming GNP-coated aggregates that refine the interfacial transition zone (ITZ) between the aggregate and the cement paste. The refined ITZ is characterized by increased density of hydration products, and crosslinked nanoplatelet structures that simultaneously enhance mechanical strength, durability, and electrical conductivity of the composite. A conductive concrete pavement system incorporating the composite is also disclosed, including embedded electrodes, temperature sensors, a power source, and a controller for automated, energy-efficient snow and ice removal. Methods of preparing the composite by pre-adsorbing GNPs onto aggregate surfaces before mixing with cement are also disclosed.

### CROSS-REFERENCE TO RELATED APPLICATIONS

This application claims priority to U.S. Provisional Patent App. No. 63/798,637 filed on May 2, 2025, the contents of which are hereby incorporated by reference in its entirety.

### TECHNICAL FIELD

The present disclosure relates to conductive cementitious composites, and more particularly to cementitious composites in which mineral aggregate are pre-coated with graphene nanoplatelets (GNPs) before mixing with cement, to methods for preparing the pre-coated aggregates and the resulting composites, and to pavement systems in which the composites are used as surface overlay for snow and ice removal by resistive heating.

### BACKGROUND

Conventional ice and snow removal from pavements rely on deicing chemicals primarily sodium chloride, magnesium chloride, and calcium chloride, combined with mechanical plowing and snow removal equipment (“SRE”). These methods produce well-documented infrastructure, environmental, and operational costs. Chloride deicing salts accelerate corrosion of reinforcing steel in concrete bridge decks and pavements, leading to premature structural deterioration. Repair of bridge decks declared structurally unsound has been estimated at $50 million to $200 million per year in the United States. Chloride runoff is associated with saline contamination of groundwater and springs in urban areas, damages roadside vegetation, and reduces aeration and water availability in soil. The use of deicing chemicals or deployment of snow removal equipment to remove snow and ice can cause damage to pavement structures, and foreign object damage risk in airport pavement environments.

The environmental and infrastructure costs associated with chemical deicing have motivated the development of alternative snow and ice removal strategies. Heated pavement systems (“HPS”) melt snow and ice using embedded heat sources. Electrically heated pavement systems (“EHPS”) use either embedded resistive cables or electrothermal concrete. The use of resistive cables embedded inside concrete structures has been applied in the past to deicing of snow and ice in Oregon, Texas, and Pennsylvania; however, in those applications the performance of the electrical cables was sometimes found inadequate due to the high power density required. Damage to electrical cables through wear and tear further limits the long-term reliability of cable-based EHPS systems.

In electrothermal concrete systems the current flow through the conductive pavement materials generates heat by conversion of electrical energy into thermal energy. Typical components of electrothermal concrete are cementitious materials, coarse and fine aggregates, water, electrically conductive additive (“ECA”), and possibly chemical admixtures. Normal Portland cement concrete (“PCC”) has an electrical resistivity in a range between 6.54×10⁵ and 11.4×10⁵ Ω-cm. Electrical resistivity of electrothermal concrete typically exhibits resistivity between about 30 Ω-cm to 1.00×10⁴ Ω-cm. Electrothermal concrete is a cementitious composite which is produced by modification of plain cementitious composites in which electricity is mainly conducted through electron transport via the added conductive phase rather than through the ionic conduction that dominates in plain PCC.

Various conductive materials have been investigated as conductive additives for electrothermal systems. Early approaches employed steel fibers and steel shavings dispersed at relatively high volume fractions as the primary conductive phase. An optimized mix proportion of approximately 20% steel shavings per volume and 1.5% steel fiber per volume of concrete was reported to be effective in resistively heating bulk concrete model bridge decks for deicing functions, with both ice melting and ice prevention processes demonstrated. Preliminary cost analysis showed that conductive concrete bridge decks using steel fibers can be less expensive than conventional concrete deicing methods such as plowing, when considering both operation and installation costs. However, the use of steel fiber as the main electrically conductive element in the concrete makes the system vulnerable to the effects of moisture-accelerated corrosion.

Carbon-based conductive additives have also been extensively explored as alternatives to steel-based systems. Carbon black has been incorporated into mortar slabs (“CBMS”) to form self-heating concrete flooring material. CBMS has been shown to heat a small room approximately 10 °C above the cold-state temperature in 330 minutes, with stable physical properties over heating periods of 72 hours. CBMS system was only tested using mortar and not concrete, leaving the heating performance of carbon black infused concrete unknown. Additionally, both carbon fiber and carbon black reinforced conductive concrete tend to require high voltages to obtain the needed heating capacity, which raises safety concerns for operation on pedestrian or automotive throughways.

Non-woven carbon fiber mats and carbon nanofiber (“CNF”) paper have been investigated as embedded resistive heating elements for concrete. These uncoated fiber mats are able to achieve a maximum self-heated temperature of 134 °C at lower power consumption. Non-woven carbon fiber mats were previously investigated only as surface-mounted heating elements and were not used as embedded interlayers in mortar or concrete samples. Specimens were tested for heating capacity and no design measures were taken for use of the carbon fiber mat as heating elements in specific applications or materials. Furthermore, CNF paper heating elements, while demonstrating sufficient heating capacity to raise mortar surface temperatures above freezing in laboratory-scale tests at 6 W of power, have primarily been validated on small 10 cm mortar cubes rather than full-scale concrete pavement systems. These mat-and-paper-based approaches function primarily as discrete interlayer heating elements rather than as structurally integrated conductive composites, limiting their scalability and compatibility with conventional concrete construction and paving techniques.

More recently, electrothermal concrete systems using low volume fractions of carbon microfibers dispersed throughout the cementitious matrix have been developed and demonstrated at full scale, including airport pavement installations. These systems achieve electrical conductivity through fiber percolation; a continuous conductive pathway when the fiber volume fraction reaches or exceeds a critical percolation threshold. Achieving high electrical conductivity in cementitious composites requires fiber percolation through the cementitious matrix, meaning that the volume fraction of fibers should be equal to or greater than the value which forms a continuous path of fibers touching one another. The range of fiber content at which electrical conductivity abruptly increases is known as the percolation transition zone. The effective carbon fiber dosage for producing electrically conductive cementitious composites is between 0.5% and 1% by volume. While carbon microfiber electrothermal concrete is promising, achieving uniform fiber dispersion throughout the concrete matrix remains challenging, particularly at the mixture cohesiveness and workability levels required for large-scale production and field placement.

Nanomaterial-modified cementitious composites have been investigated as an alternative route to conductive concrete. Carbon nanotubes (CNTs), carbon nanofibers (CNFs), and graphene nanoplatelets (GNPs), can enhance the mechanical and conductive properties of cement composites. Among these nanomaterials, GNPs exhibit high aspect ratio, large specific surface area, and mechanical strength that make them attractive candidates for reinforcement and for electron transport in cementitious matrices. However, dispersion of GNPs in the bulk cement paste is constrained by agglomeration in the highly alkaline pore solution, which is driven by electrostatic interactions between negatively charged graphene-based sheets and Ca²⁺, K⁺, and Na⁺ ions in the pore solution. Agglomerated nanomaterial acts as a defect that undermines reinforcement and can degrade composite performance. The current approaches to disperse GNPs in the cement matrix include the use of admixtures such as polycarboxylate superplasticizer and application of ultrasonication energy.

Concrete is a multiphase composite material at the microstructural level that includes three main phases: aggregate particles, bulk cement paste (matrix), and an interfacial transition zone (ITZ) between the aggregates and the matrix. The ITZ is generally known to be the weakest zone in cementitious composites, characterized by its relatively less compaction and higher porosity compared to the cement matrix itself. The ITZ typically refers to a thin-shell region of about 5 to 100 micrometers thick surrounding aggregate particles. In an engineering mechanics model, hydrate failure in the ITZ is revealed to govern the concrete strength. A weak interface region of typically 4 to 30 micrometers thick that exists between fine aggregate and the cement matrix in cement mortar also significantly influences its engineering performance. Fine aggregate occupies approximately 60-75% by volume of a typical cement mortar. In concrete, fine and coarse aggregates together typically account for 60-75% of the total volume.

Building on the high aggregate volume fraction in cementitious composites, an approach investigated involves coating aggregate particles with nanomaterials as an alternative to dispersing the nanomaterials throughout the bulk cement paste. In this approach, fine or coarse aggregates may be pre-treated with nanomaterials such as graphene oxide, using techniques such as solution-based deposition, dip-coating, spray-coating, and surfactant-assisted electrostatic deposition prior to mixing. However, such investigation has been limited largely to cement paste or mortar specimens at laboratory scale and has not established coating retention under wet mixing and casting.

There remains a need for a conductive cementitious composite that achieves enhanced electrical and thermal conductivity through targeted nanoengineering of the aggregate-matrix interface, while maintaining the mechanical properties and constructability required for full-scale pavement applications.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

The present disclosure provides conductively coated mineral aggregates, cementitious composites comprising the conductively coated aggregates, electrothermal pavement systems incorporating the composites, and methods of preparing the conductively coated aggregates and the composites.

In one aspect, a conductively coated mineral aggregates is provided. The conductively coated mineral aggregate comprises a mineral aggregate particle bearing a surface coating formed from an aqueous dispersion of graphene nanoplatelets (GNPs). The mineral aggregate particle may be a fine aggregate particle, a coarse aggregate particle, or a combination thereof. In some embodiments, the coating is retained on the aggregate particle after re-immersion of the coated aggregate in water, which indicates a strong coating-aggregate interaction and supports use of the coated aggregate in conventional concrete mixing and placement operations.

The present disclosure provides three methods of preparing the conductively coated aggregates. The methods comprise pre-conditioning a mineral aggregate particle by washing and drying to remove surface moisture and contaminants; using an aqueous dispersion of GNPs with a superplasticizer under ultrasonication; and applying the GNPs to a surface of the mineral aggregate particle by one of the three coating methods described below. The mineral aggregate particle may be fine aggregate, coarse aggregate, or a combination thereof. Using the first method, GNP-coated aggregates (GNP-A) may be prepared by immersing the aggregates in the GNP dispersion to adsorb the GNPs onto the aggregate surfaces. Using the second method, GNP-coated aggregates (CSGNP-A) may be prepared by adding a cement slurry to the GNP dispersion to form a cement-GNP slurry which is applied to a pre-conditioned mineral aggregate particle on a heated surface and dried. Using the third method, the mineral aggregate particles are first treated with a hydrated lime, dried, and then sprayed with the GNP dispersion on a heated surface and dried, producing a hydrated-lime/GNP-coated aggregate (HLGNP-A). Each route produces a conductively coated aggregate with surface features and coating chemistry that differ in controlled ways, allowing the formulator to adjust the coating to the aggregate composition, cement type, and service environment at hand.

The present disclosure further provides methods of preparing the conductive cementitious composite. The cementitious composite comprises a Type 1L Portland-limestone cement matrix, and fine and coarse aggregates that have been pre-treated with graphene nanoplatelets (GNPs) at dosages of 0.1% by weight of cement to up to 0.4% by weight of cement by any of the routes described above. The GNPs are pre-adsorbed onto the aggregate surfaces to form GNP-coated aggregates, wherein the GNPs arrange as crosslinked nanoplatelet structures at the aggregate-matrix interface rather than dispersed in the bulk cement paste. In optional embodiments, macroscale conductive fibers, such as carbon fibers, may be further distributed in the cementitious matrix to form a continuous conductive network that bridges the GNP-coated aggregates and provides additional structural reinforcement. The resulting composite may be prepared using conventional concrete mixing and placement equipment and techniques.

In another aspect, an electrothermal pavement system is provided. The system comprises the cementitious composite described above, first and second electrodes in electrical contact with the composite and spaced apart from one another, a power source electrically connected to the first and second electrodes, and an electrical insulation layer disposed between the composite and an underlying substrate. In some embodiments, temperature sensors embedded in the composite are used, and a controller operatively connected to the power source and to the temperature sensors and configured to modulate the voltage or current supplied to the composite. In some embodiments, the cementitious composite is disposed as a surface overlay on an existing pavement substrate, with the electrical insulation layer interposed between the composite and the existing pavement substrate, so that the composite retrofits the existing pavement for electrothermal snow and ice removal without replacement of the underlying structure.

The foregoing general description of the illustrative embodiments and the following detailed description thereof are merely exemplary aspects of the teachings of this disclosure and are not restrictive. Additional features and advantages of the disclosure will be described hereinafter.

### BRIEF DESCRIPTION OF THE DRAWINGS

Aspects of the present disclosure are illustrated by way of example and are not limited by the accompanying figures for which like references indicate like elements. The drawings are not necessarily to scale, and certain features may be exaggerated or hidden to better illustrate and explain an innovative aspect of an example. Further, the exemplary illustrations described herein are not exhaustive or otherwise limiting, and embodiments are not restricted to the precise form and configuration shown in the drawings or disclosed in the following detailed description.

FIG. 1 is a schematic cross-sectional view of a single GNP-coated aggregate grain embedded in a cement mortar matrix according to an example, showing the aggregate core, the graphene nanoplatelet (GNP) coating layer disposed on a surface of the aggregate core, the interfacial transition zone formed between the GNP coating layer and the cement mortar matrix, and the cement mortar matrix surrounding the GNP-coated aggregate grain.

FIG. 2 is a schematic cross-section of a hardened cementitious composite according to one or more examples, showing a plurality of GNP-coated aggregate particles dispersed in a continuous cementitious matrix, an interfacial transition zone (ITZ) at each aggregate surface enriched with the GNP phase relative to the bulk matrix, and a representative continuous percolation (conductive) pathway formed by interconnected GNP-enriched ITZs of adjacent coated aggregates.

FIG. 3 is a schematic view illustrating the conductive-path architecture of the cementitious composite according to an example, in which a percolating conductive network arises from aggregate-shell-to-aggregate-shell contact through the ITZ network and, in embodiments further including an optional macroscale conductive fiber dispersed in the cementitious matrix, from fiber-to-coated-aggregate contact in addition.

FIG. 4 illustrates a flowchart of a method of preparing GNP-coated aggregates (GNP-A), according to an example.

FIG. 5 illustrates a flowchart of a method of preparing cement slurry and GNP hybrid coated aggregates (CSGNP-A), according to an example.

FIG. 6 illustrates a flowchart of a method of preparing hydrated lime and GNP hybrid coated aggregates (HLGNP-A), according to an example.

FIG. 7 illustrates a flowchart of a method of preparing a conductive cementitious composite, according to an example.

FIG. 8 is a thermogravimetric analysis (TGA) and derivative thermogravimetric (DTG) plot of an uncoated dolomitic limestone control aggregate.

FIG. 9 is a TGA and DTG plot of a sonicated GNP suspension residue, used as a GNP-only control.

FIG. 10 is a DTG plot of GNP-A coated aggregate, before and after a mechanical-agitation rinse protocol, over the temperature range 25 °C to 1000 °C.

FIG. 11 is a DTG plot of GNP-A coated aggregate, before and after a mechanical-agitation rinse protocol, over the temperature range 300 °C to 500 °C, showing the GNP combustion peak.

FIG. 12 is a DTG plot of CSGNP-A coated aggregate, before and after a mechanical-agitation rinse protocol, over the temperature range 25 °C to 1000 °C.

FIG. 13 is a DTG plot of CSGNP-A coated aggregate, before and after a mechanical-agitation rinse protocol, over the temperature range 300 °C to 500 °C, showing the GNP combustion peak.

FIG. 14 is a DTG plot of HLGNP-A coated aggregate, before and after a mechanical-agitation rinse protocol, over the temperature range 25 °C to 1000 °C.

FIG. 15 is a DTG plot of HLGNP-A coated aggregate, before and after a mechanical-agitation rinse protocol, over the temperature range 300 °C to 500 °C, showing the GNP combustion peak.

FIG. 16 is a scanning electron microscopy (SEM) micrograph of an uncoated aggregate surface, showing the porous microstructure of the substrate.

FIG. 17 is an SEM micrograph of a GNP-A coated aggregate surface, showing GNP platelets visibly deposited and partially overlapping on the aggregate surface.

FIG. 18 is an SEM micrograph of a CSGNP-A coated aggregate surface, showing GNPs embedded within and partially covered by hydration products.

FIG. 19 is an SEM micrograph of an HLGNP-A coated aggregate surface, showing a denser, more uniform GNP-and-hydrate layer on the aggregate surface.

FIGS. 20A and 20B are a cross-sectional SEM micrograph of fractured concrete specimens after compressive strength testing, showing (A) a crack-at-ITZ failure mode for a Plain Concrete control and (B) a well-bonded ITZ for HLGNP-A.

FIG. 21 is a schematic of an electrical conductivity test setup, comprising a prismatic specimen of approximately 40 mm×40 mm×160 mm having first and second embedded mesh electrodes separated by approximately 140 mm and connected by lead wires to an LCR meter.

FIG. 22 is a data plot of the 28-day AC bulk resistivity of the cementitious composite as a function of GNP shell loading, on a logarithmic ordinate, with error bars representing the standard deviation of n≥3 replicates per loading point.

FIG. 23 is a schematic cross-sectional view of a heat flow meter apparatus configured for steady-state thermal conductivity measurement of the cementitious composite according to ASTM C518, comprising a hot plate, an upper heat flux transducer, a specimen of the cementitious composite, a lower heat flux transducer, a cold plate, and upper and lower surface thermocouples in contact with the respective faces of the specimen.

FIG. 24 is a data plot of the 28-day thermal conductivity of the cementitious composite as a function of GNP shell loading at room temperature.

FIG. 25 is a schematic side view of a Joule heating test apparatus for the cementitious composite, comprising an AC power supply, a first lead wire, a first electrode, a slab specimen of the cementitious composite, a second electrode, a second lead wire, and a plurality of surface thermocouples in contact with an upper surface of the slab specimen.

FIG. 26 is a data plot of the surface temperature increase of the cementitious composite as a function of time under a constant applied AC voltage.

FIG. 27A is a schematic cross-sectional view of a pavement-scale conductive concrete layer disposed as a surface overlay on an existing pavement substrate with an intervening electrical insulation layer, showing first and second embedded electrodes connected to an AC power unit and a thermocouple grid (TC A-1, TC A-2, TC A-3, TC B-1, TC B-2, TC B-3, TC C-1, TC C-2, TC C-3) distributed within the conductive concrete layer for in-situ temperature monitoring during electrothermal operation.

FIG. 27B is a schematic view of a conductive concrete layer showing a cementitious composite with embedded electrodes according to the disclosure.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein. The following detailed description is provided to enable one of ordinary skill in the art to practice the invention and should be read in conjunction with the accompanying drawings. While most of the terms used herein will be recognizable to those of ordinary skill in the art, it should be understood that when not explicitly defined, terms should be interpreted as adopting a meaning presently accepted by those of ordinary skill in the art. The particulars shown herein are by way of example and for purposes of illustrative discussion only and are presented in the cause of providing what is believed to be the most useful and readily understood description of the principles and conceptual aspects of various embodiments of the invention.

The present disclosure relates to a nanoengineered conductive cementitious composite, methods for its preparation, methods for conductively coating aggregates for cementitious composites, and its use in an electrothermal concrete pavement system, aimed at improving urban mobility and safety in winter conditions by addressing challenges associated with snow and ice accumulation on road surfaces. The cementitious composite comprises conductively coated aggregates of fine and/or coarse aggregate particles coated (pre-coated) with graphene nanoplatelets (GNPs), optionally together with macroscale components such as macroscale carbon fibers, that are dispersed within the cementitious matrix to form a continuous network, enabling efficient snow and ice removal with minimal energy consumption. The composite delivers GNPs directly to the aggregate-matrix interface through pre-adsorption onto aggregate surfaces, rather than dispersing nanomaterials throughout the bulk cementitious matrix. The GNPs are positioned at the interfacial transition zone (ITZ) between the aggregates and the cementitious matrix.

According to the disclosure, there is provided an electrically conductive and thermally responsive concrete manufactured using Type 1L Portland-limestone cement and aggregates pre-treated with graphene nanoplatelets (GNPs) at dosages of up to 0.4% by weight of cement. Methods of preparing the composite by pre-adsorbing GNPs onto aggregate surfaces before mixing with cement are disclosed herein. The GNPs are pre-adsorbed onto the aggregate surfaces prior to mixing with cement, forming GNP-coated aggregates that modify the interfacial transition zone (ITZ) between the aggregate and the cement paste. An electrothermal concrete pavement system is also disclosed, including embedded electrodes, temperature sensors, a power source, and a controller for automated, energy-efficient snow and ice removal. In some aspects, the composite may be used as a surface overlay on existing pavement infrastructure.

The cementitious composite of the present disclosure comprises a cementitious matrix, fine and coarse aggregates, and graphene nanoplatelets (GNPs) that are pre-adsorbed onto the surfaces of the aggregates (coarse and/or fine aggregates) to form GNP-coated aggregates prior to mixing with the cement. The cementitious composite may further include optional macroscale components. The GNPs are not dispersed in the bulk cementitious matrix; rather, they are targeted specifically to the aggregate surfaces so that, upon mixing with cement and water, the GNPs are positioned at the interfacial transition zone (ITZ) between the aggregate and the cement paste. This targeted delivery modifies the ITZ, producing a composite with improved mechanical strength, and enhanced electrical and thermal conductivity relative to conventional concrete. The provision of nanocoated aggregates ensures that the conductivity and mechanical properties of the concrete are maintained uniformly across large surfaces.

The cementitious matrix may include Type 1L Portland-limestone cement, conforming to ASTM C595. Type 1L is a Portland-limestone cement in which limestone is interground with portland cement clinker, providing a cementitious binder with reduced clinker content and performance characteristics suitable for pavement applications. The use of Type 1L reflects current industry trends and provides potentially improved compatibility with supplementary cementitious materials (SCMs) like slag and fly ash. In a preferred embodiment, the cementitious matrix consists essentially of Type 1L Portland-limestone cement and water. It will be appreciated that in alternative embodiments, the cementitious matrix may include other types of hydraulic cement, including but not limited to ordinary Portland cement (OPC Type I, II, III, IV, or V), rapid hardening cement, low heat cement, sulphate resisting cement, white cement, air entraining cement, expansive cement, Portland-slag cement, Portland-pozzolan cement, ternary blended cement, high alumina cement, and combinations thereof, without departing from the scope of the disclosure.

As used herein, an “aggregate” is a mineral particulate material in accordance with ASTM C33, a standard known to those skilled in the art, and includes a coarse aggregate (i.e., a mineral particulate material substantially retained on a 4.75 mm (No. 4) sieve) and a fine aggregate (i.e., a mineral particulate material substantially passing a 4.75 mm (No. 4) sieve). In a preferred embodiment, the fine aggregate is a natural siliceous sand and the coarse aggregate is a crushed limestone. It will be understood that the aggregates are not restricted to a single lithology. In one embodiment, the aggregate is selected from the group consisting of limestone, granite, basalt, quartzite, dolomite, river gravel, crushed quarry stone, silica sand, recycled concrete aggregate, and combinations thereof. In one embodiment, the aggregate is a coarse aggregate. In another embodiment, the aggregate is a fine aggregate. In another embodiment, the aggregate includes both a coarse aggregate fraction and a fine aggregate fraction.

Prior to coating, the aggregates may be washed with water to remove loose fines and oven-dried at about 105 °C for about 24 hours to remove surface moisture and contaminants. This pre-conditioning step ensures a clean, dry aggregate surface that promotes uniform adsorption or adhesion of the GNP coating.

As used herein, a “graphene nanoplatelets” or “GNPs” are two-dimensional carbon nanomaterials comprising multiple stacked graphene layers, characterized by a high aspect ratio, large specific surface area, excellent electrical and thermal conductivity, and mechanical strength. The GNPs used in the present invention are pristine multilayer graphene flakes with sp²-preserved basal planes. In one embodiment, the GNP includes commercially available GNP from 10 to 15 stacked layers, has a thickness in a range of from 3 nm to 10 nm, a lateral dimension in a range of from 5 μm to 10 μm, a bulk density in a range of from 0.13 g/cm³ to 0.16 g/cm³, a specific surface area of approximately 500 m²/kg (BET, N₂), and an intrinsic in-plane thermal conductivity in a range of from 200 W/(m·K) to 1,500 W/(m·K). The physical and spectroscopic properties of an example GNP source material as supplied to the inventor laboratory are presented in TABLE 1.

TABLE 1
Physical and spectroscopic properties of the GNP source material.

| Parameter | Value |
|---|---|
| Number of stacked layers | 10 to 15 |
| Thickness | 3 nm to 10 nm |
| Lateral dimension (D₅₀) | 5 μm to 10 um |
| Bulk density | 0.13 g/cm³ to 0.16 g/cm³ |
| Specific surface area (BET, N₂) | ≈500 m²/kg |
| Intrinsic in-plane thermal conductivity | 200 W/(m · K) to 1,500 W/(m · K) |

An aqueous dispersion (suspension) of GNPs is prepared by dispersing GNPs in water with the assistance of a superplasticizer (e.g., polycarboxylate ether (PCE), sulfonated naphthalene formaldehyde (SNF/PNS), and/or sulfonated melamine formaldehyde (SMF)), followed by ultrasonication to achieve a stable, well-dispersed suspension. The concentration of GNPs in the aqueous dispersion may be from about 0.1 mg/mL to about 10 mg/mL, and in certain embodiments from about 0.5 mg/mL to about 5 mg/mL. The superplasticizer aids in the dispersion and stabilization of the GNPs in the aqueous medium and prevents re-agglomeration. The aqueous GNP dispersion may be referred to herein as the “GNP suspension.”

As used herein, the “interfacial transition zone” or “ITZ” is the thin shell of cement paste, of thickness on the order of from 5 μm to 100 μm, surrounding an aggregate particle in a hardened concrete. The ITZ is generally recognized as the weakest zone in cementitious composites, characterized by higher porosity, lower packing density of cement grains, a higher concentration of calcium hydroxide (CH) crystals, and preferential orientation of CH crystals relative to the bulk paste. Due to the wall effect, the ITZ generally features a larger interparticle spacing than the bulk paste, and the first cracks due to loading typically appear in the vicinity of the aggregate and strongly influence the fracture behavior of the composite.

The GNPs in accordance with the present disclosure are not dispersed in the bulk cement paste or mixing water. Instead, the GNPs are pre-adsorbed or pre-coated onto the aggregate surfaces prior to mixing with cement, as described in detail below. This targeted delivery approach positions the GNPs at the ITZ, which is the weakest and most performance-critical zone in the composite, rather than distributing them throughout the matrix. The present disclosure provides three methods for coating the aggregates with GNPs, each producing modified aggregates with GNP-enhanced surfaces that refine the ITZ upon mixing with cement. As used herein, a “GNP-coated aggregate” is a fine or coarse aggregate particle, the exterior surface of which carries a continuous, or substantially continuous, shell of GNPs prepared by any one of three methods, hereinafter described. The three methods produce, respectively: (a) GNP-coated aggregates (“GNP-A”); (b) cement slurry and GNP hybrid coated aggregates (“CSGNP-A”); and (c) hydrated lime and GNP hybrid coated aggregates (“HLGNP-A”). The coated aggregates are sized to match the target particle size distribution of the final concrete, are re-checked for loose or non-adherent GNP by a gentle water rinse followed by filtration and mass balance and are stored in sealed containers prior to use. The water absorption of the resulting GNP-coated aggregates in accordance with ASTM C127, a standard known to those skilled in the art is evaluated relative to the uncoated aggregate.

In a first method, the pre-conditioned, oven-dried aggregates (fine and/or coarse) are directly immersed in the GNP suspension to allow adsorption of GNPs onto the aggregate surfaces. The immersion time may be about 30 minutes under occasional stirring. The GNPs adsorb onto the aggregate surfaces through physical entrapment in the surface microtexture of the aggregate particles. After immersion, the aggregates are removed from the GNP suspension and oven-dried at about 60 °C to about 80 °C for 12 to 24 hours. The resulting GNP-coated aggregates (GNP-A) exhibit a visible darkening of the surface, indicating successful adsorption of GNPs.

In a second method, a cement-GNP slurry (e.g., Type 1L cement) is applied to the aggregate surfaces. The cement slurry is added to the GNP suspension at a ratio of about 5 grams per 100 cm³ of suspension and mixed to obtain a homogeneous cement-GNP slurry. The cement-GNP slurry is then sprayed onto oven-dried aggregates placed on a heated surface. The heated surface may be maintained at a temperature of about 60 °C, to promote rapid evaporation of the water carrier and adhesion of the cement-GNP layer to the aggregate surface. After complete drying, the coated aggregates are cooled to room temperature and cured at 23 °C±2 °C and greater than or equal to 95 percent relative humidity for 24 to 72 hours before being incorporated into a concrete batch. The resulting coated aggregates (CSGNP-A) have a composite coating layer comprising both cementitious particles and GNPs, which serves both as the delivery medium and as the chemically active precursor to a permanent calcium silicate hydrate (C—S—H)-rich matrix that anchors the GNPs to the aggregate surface. The resulting coating on the aggregate surface contains, on completion of curing, a mineralized cement-hydrate matrix in which the GNPs are embedded. The matrix provides a covalent-chemistry-grade anchoring pathway to the aggregate surface.

In a third method, a two-step hybrid coating is applied. First, the oven-dried aggregates are immersed in a hydrated lime (calcium hydroxide, Ca(OH)₂) slurry and then dried to form a surface-treated lime surface in order to pre-establish a calcium-rich, alkaline microenvironment at the aggregate surface. The hydrated lime may have a concentration of about 1 gram to about 20 grams of hydrated lime per 100 cm³ of water. Second, the lime-treated aggregates are placed on a heated surface and sprayed with the GNP suspension. The heated surface may be maintained at a temperature of about 60 °C. The aggregates are kept under heating until fully dried to ensure adhesion of the GNP coating onto the lime-treated surface. The resulting hydrated lime and GNP hybrid coated aggregates (HLGNP-A) have a layered coating comprising an inner lime-treated surface and an outer GNP layer. The hydrated lime pre-treatment may provide a treated surface for the GNP functional components to bond and increase the retention of the GNPs on the aggregate surface. Additionally, during subsequent cement hydration in the final concrete, Ca(OH)₂ is consumed by pozzolanic and carbonation reactions to yield additional C—S—H and calcium carbonate in the immediate vicinity of the aggregate surface. Pre-positioning Ca(OH)₂ at the aggregate-shell interface therefore provides a chemical driver for the nucleation of C—S—H on and around the GNPs during cement hydration, further anchoring the shell and further densifying the ITZ. As established in the working examples hereinafter described, HLGNP-A exhibited the highest GNP retention, the highest 28-day compressive strength, and the highest thermal conductivity among the three methods. It is believed that the Ca(OH)₂ underlayer (i) provides a calcium-rich, alkaline microenvironment that favors C—S—H nucleation around the GNP platelets during subsequent cement hydration, and (ii) provides a chemically reactive interface that anchors the GNP shell to the aggregate surface.

For comparison and evaluation purposes, control aggregates may be prepared following the same procedures but without the addition of graphene nanoplatelets (GNPs). As used herein, a “control aggregate” is a fine or coarse aggregate particle prepared by the apparatus and procedure of one of the three methods described above with omission of the GNP component. All control aggregates are first washed with water and oven-dried at about 105 °C for about 24 hours, consistent with the pre-conditioning of the GNP-coated aggregates. A cement slurry control aggregate (“CS-A”) is prepared by dispersing Type 1L cement in water at a ratio of about 5 grams per 100 cm³ and spraying the slurry onto aggregates placed on a heated surface, followed by drying under heating until complete moisture removal. A hydrated lime control aggregate (“HL-A”) is prepared by immersing aggregates in a hydrated lime prepared in deionized water, removing the aggregates, and drying under the same heating conditions. No GNPs are incorporated in either control aggregate. Uncoated, untreated aggregate may also serve as a plain control (“Control-A”). The control aggregates allow the effects of the GNPs to be isolated from the effects of the cement slurry or hydrated lime surface treatment alone.

By pre-coating the aggregates with GNPs prior to mixing with cement, the GNPs are positioned directly at the ITZ upon hydration. The GNPs at the aggregate surface serve multiple functions: (a) they act as nucleation templates for cement hydration products, promoting the formation of denser C—S—H gel and reducing the concentration of large, oriented CH crystals; (b) they form crosslinked nanoplatelet structures that bridge microcracks and inhibit crack propagation through the ITZ; (c) they fill nanoscale voids and reduce the porosity of the ITZ; and (d) they provide nanoscale conductive pathways at the aggregate-matrix interface, enhancing the electrical conductivity of the composite.

Thermogravimetric analysis (TGA) was performed by the inventor laboratory on GNP-coated aggregate before and after mechanical agitation, at GNP loadings of 0.1, 0.2, 0.3, and 0.4 wt %. The 300 °C to 425 °C mass-loss area in the TGA plot is the principal signature of the GNP shell and is the basis for SRI quantification. Aggregate-only control TGA showed minimal mass loss until approximately 700 °C, at which carbonate decomposition begins. Sonicated GNP-only TGA showed mass loss between 300 °C and 425 °C, consistent with graphene oxidation and combustion in air. The two control runs together establish that the 300 °C to 425 °C step is unambiguously attributable to the GNP shell. TABLE 2 presents the measured TGA mass-loss step before mechanical agitation, TABLE 3 presents the measured TGA mass-loss step after mechanical agitation, and TABLE 4 presents the corresponding GNP retention (SRI) for each of the three coated aggregate types at each of the four GNP loadings.

As used herein, the “shell retention index” or “SRI” is a dimensionless quality-control parameter equal to the mass of GNP retained on the coated aggregate after a specified mechanical-agitation rinse protocol divided by the mass of GNP deposited prior to the rinse, expressed as a percentage. The SRI is quantified by the difference in the 300 °C to 425 °C. TGA mass-loss step before and after agitation.

TABLE 2
TGA mass-loss step in the 300 °C to 425 °C window for GNP-A, CSGNP-A,
and HLGNP-A coated aggregates at GNP loadings of 0.1, 0.2, 0.3, and
0.4 wt %, measured prior to the mechanical-agitation rinse protocol.

| Sample | 0.1 wt % | 0.2 wt % | 0.3 wt % | 0.4 wt % |
|---|---|---|---|---|
| GNP-A | 0.39 | 0.52 | 0.68 | 0.75 |
| CSGNP-A | 0.31 | 0.41 | 0.54 | 0.59 |
| HLGNP-A | 0.61 | 0.88 | 1.06 | 1.21 |

TABLE 3
TGA mass-loss step in the 300 °C to 425 °C window for
GNP-A, CSGNP-A, and HLGNP-A coated aggregates at
GNP loadings of 0.1, 0.2, 0.3, and 0.4 wt %, measured
after the mechanical-agitation rinse protocol.

| Sample | 0.1 wt % | 0.2 wt % | 0.3 wt % | 0.4 wt % |
|---|---|---|---|---|
| GNP-A | 0.15 | 0.19 | 0.20 | 0.19 |
| CSGNP-A | 0.22 | 0.28 | 0.35 | 0.35 |
| HLGNP-A | 0.50 | 0.71 | 0.83 | 0.92 |

TABLE 4
Shell retention index (SRI) of GNP-A, CSGNP-A, and HLGNP-A coated aggregates
at GNP loadings of 0.1, 0.2, 0.3, and 0.4 wt %, calculated from the difference in the
300 °C to 425 °C TGA mass-loss step before and after the mechanical-agitation
rinse protocol.

| Sample | 0.1 wt % | 0.2 wt % | 0.3 wt % | 0.4 wt % |
|---|---|---|---|---|
| GNP-A | 38.5 | 36.0 | 29.0 | 25.0 |
| CSGNP-A | 71.0 | 68.0 | 64.0 | 60.0 |
| HLGNP-A | 82.5 | 80.5 | 78 | 75.5 |

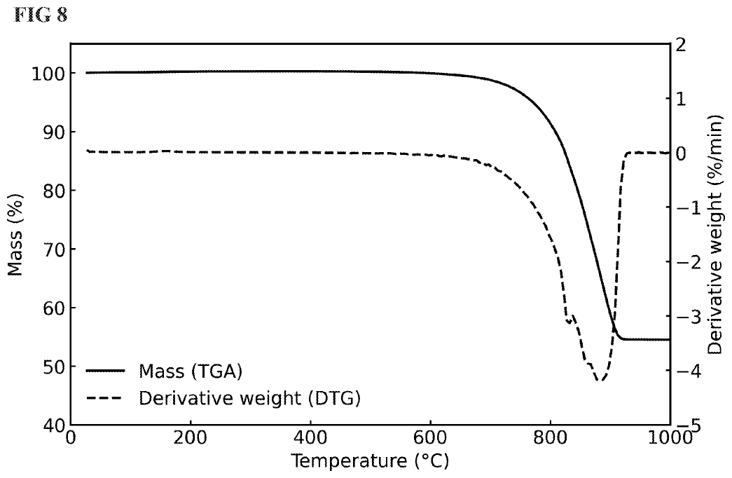

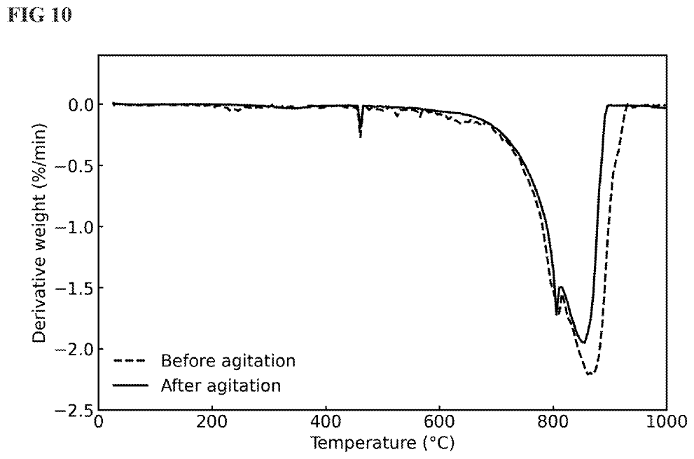

FIG. 8 shows the TGA mass-loss curve (solid line, left ordinate) and the corresponding DTG curve (dashed line, right ordinate) for the uncoated dolomitic limestone aggregate substrate, measured under an oxygen-rich atmosphere at a heating rate of 10 °C/min from 25 °C to 1025 °C. The mass curve is essentially flat from 25 °C to approximately 700 °C, indicating that the substrate undergoes no measurable mass loss in the 300 °C to 425 °C window in which GNP combustion occurs. The principal mass-loss event is a single sharp DTG peak centered near 850 °C, attributable to the thermal decomposition of carbonate phases (CaMg(CO₃)₂, and calcite, CaCO₃) into the corresponding oxides with release of CO₂. FIG. 8 establishes that any 300 °C to 425 °C mass loss observed in the GNP-coated aggregate samples (FIGS. 10 to 15) is unambiguously attributable to the GNP shell and not to the substrate.

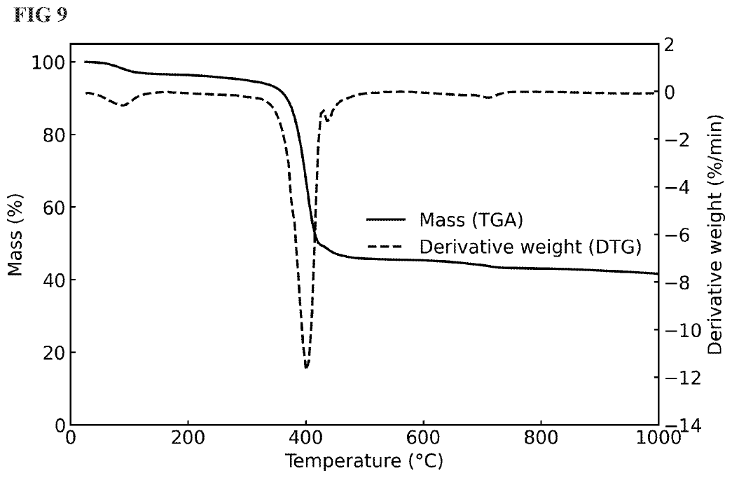

FIG. 9 shows the TGA mass-loss curve (solid line, left ordinate) and the corresponding DTG curve (dashed line, right ordinate) for a GNP-only control prepared by drying a GNP suspension. The DTG trace exhibits a single dominant peak centered near 400 °C, with a peak amplitude of approximately 12%/min, reflecting the oxidation and combustion of graphenic carbon in air. The mass curve drops sharply across the 300 °C to 425 °C window from approximately 90% to approximately 50% of the initial sample mass, with the residual mass attributable to non-combustible additives present in the suspension. FIG. 9 confirms that the 300 °C to 425 °C mass-loss step is the diagnostic signature of GNP combustion in the GNP-coated aggregate samples.

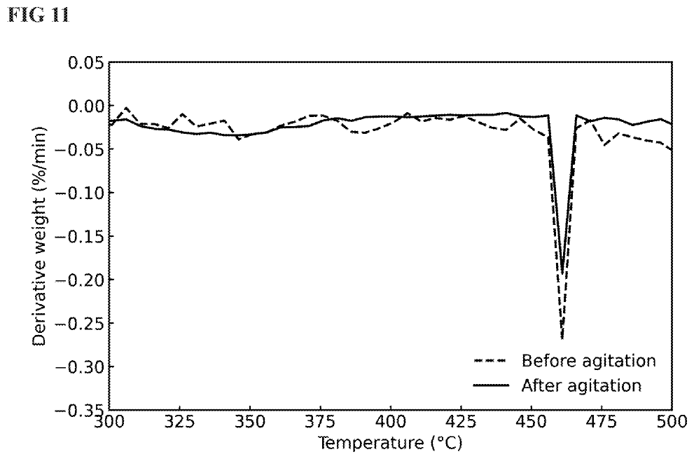

FIG. 10 shows the DTG curves for GNP-A coated aggregate before mechanical agitation (dashed line) and after mechanical agitation (solid line), measured under the same TGA conditions described for FIG. 8, over the temperature range 25 °C to 1000 °C. Both curves are dominated by a large carbonate-decomposition peak near 850 °C, consistent with the dolomitic substrate. The 300 °C to 425 °C window is examined in detail in FIG. 11.

FIG. 11 shows the DTG curves for GNP-A coated aggregate before mechanical agitation (dashed line) and after mechanical agitation (solid line) over the temperature range 300 °C to 500 °C. A pair of narrow GNP combustion peaks is centered near 460 °C in both traces. The peak intensity decreases substantially after mechanical agitation, from approximately 0.27%/min before agitation to approximately 0.19%/min after agitation. The corresponding integrated mass-loss step in the 300 °C to 425 °C window decreases from 0.39% to 0.15%, giving a shell retention index (SRI) for GNP-A of 38.5% at 0.1 wt % GNP loading.

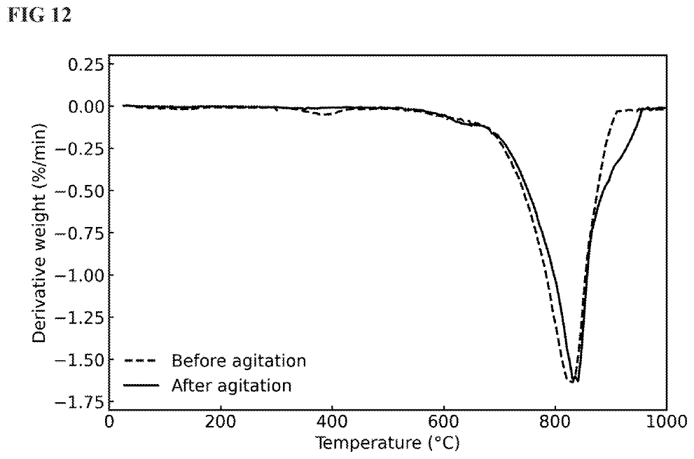

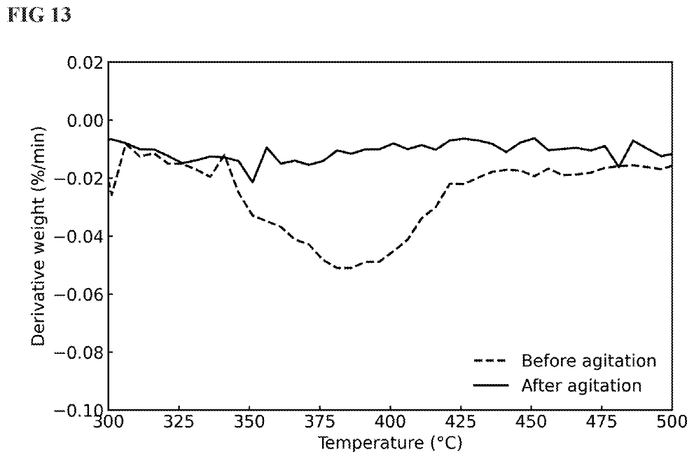

FIG. 12 shows the DTG curves for CSGNP-A coated aggregate before mechanical agitation (dashed line) and after mechanical agitation (solid line) over the temperature range 25 °C to 1000 °C. Both traces show a broad carbonate-decomposition feature near 850 °C, broadened relative to FIG. 10 by the additional carbonate contribution from the surrounding cement-slurry layer. The 300 °C to 425 °C window is examined in detail in FIG. 13.

FIG. 13 shows the DTG curves for CSGNP-A coated aggregate before mechanical agitation (dashed line) and after mechanical agitation (solid line) over the temperature range 300 °C to 500 °C. The before-agitation trace shows a broad shoulder centered near 385 °C with a peak amplitude of approximately 0.05%/min, reflecting GNP platelets distributed throughout the cement-slurry coating layer rather than concentrated at a single interface. The after-agitation trace shows that this shoulder is substantially preserved, indicating that GNP platelets embedded in the C—S—H matrix are not readily removed by mechanical agitation. The corresponding integrated mass-loss step in the 300 °C to 425 °C window decreases only modestly from 0.31% to 0.22%, giving an SRI for CSGNP-A of 71.0% at 0.1 wt % GNP loading.

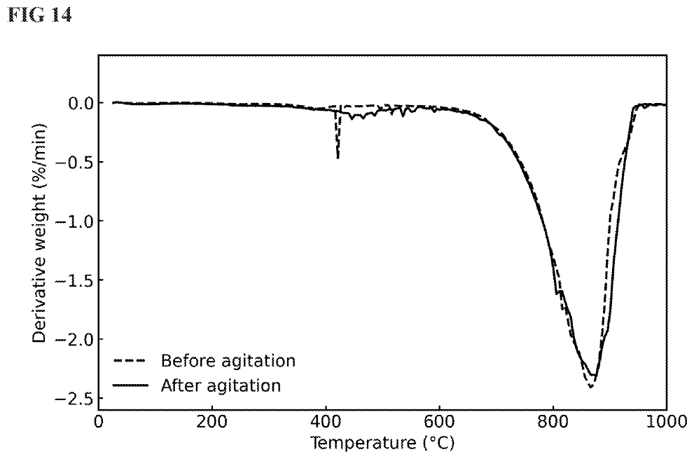

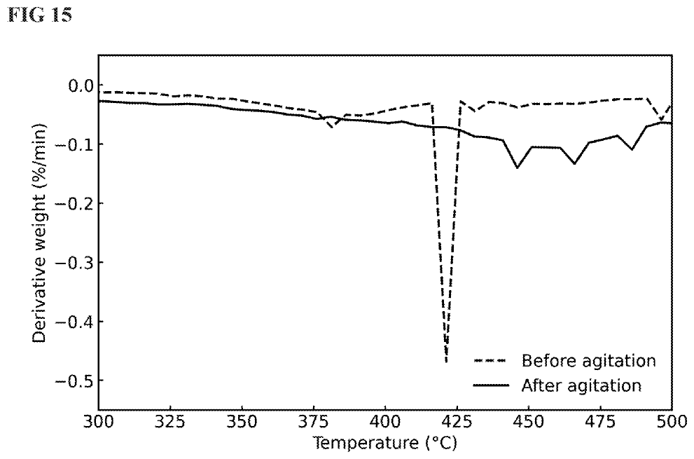

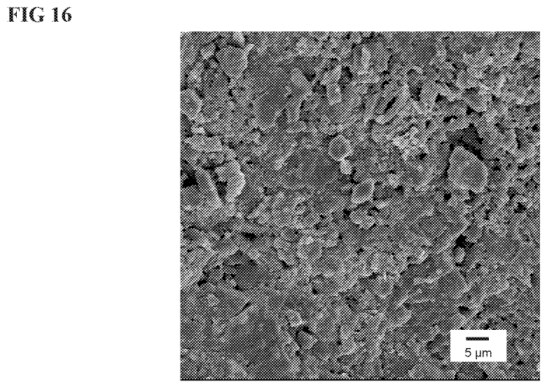

FIG. 14 shows the DTG curves for HLGNP-A coated aggregate before mechanical agitation (dashed line) and after mechanical agitation (solid line) over the temperature range 25 °C to 1000 °C. Both traces show a complex carbonate-decomposition feature near 850 °C, with an additional shoulder near 700 °C attributable to dehydroxylation and/or decarbonation of the hydrated-lime underlayer. The 300 °C to 425 °C window is examined in detail in FIG. 15.

FIG. 15 shows the DTG curves for HLGNP-A coated aggregate before mechanical agitation (dashed line) and after mechanical agitation (solid line) over the temperature range 300 °C to 500 °C. The before-agitation trace shows a sharp GNP combustion peak centered near 421 °C with a peak amplitude of approximately 0.47%/min, the largest of the three coating methods at 0.1 wt % GNP loading and consistent with the highest deposited mass of GNP. The after-agitation trace shows the peak amplitude reduced to approximately 0.14%/min, but the sharp peak feature persists, indicating that the GNP shell anchored at the Ca(OH)₂ to C—S—H interface is the most retentive of the three coating architectures. The corresponding integrated mass-loss step in the 300 °C to 425 °C window decreases from 0.61% to 0.50%, giving an SRI for HLGNP-A of 82.5% at 0.1 wt % GNP loading.

The shell-adhesion mechanism for each method is proposed as follows. In the first method, the GNP shell is held to the aggregate surface principally by van der Waals adhesion between the GNP basal planes and the mineral surface, supplemented by mechanical interlocking with surface roughness. At a GNP loading of 0.1 wt %, the SRI for GNP-A measured 38.5%, indicating that a substantial fraction of the deposited GNP was removed by mechanical agitation; this finding motivated the development of the second and third methods. In the second method, the cement slurry hydrated on the aggregate surface to form a C—S—H matrix in which the GNP platelets were embedded; at 0.1 wt %, the SRI rose to 71%. In the third method, the Ca(OH)₂ underlayer reacts with the surrounding cement matrix during subsequent concrete hydration to form additional C—S—H, and the GNP shell is anchored at the interface between the two reactive layers; at 0.1 wt %, the SRI was the highest of the three methods at 82.5%. The same trend in retention among the three methods (HLGNP-A>CSGNP-A>GNP-A) was observed at GNP loadings of 0.2, 0.3, and 0.4 wt %. The SRI for each method decreased monotonically with increasing GNP loading, consistent with progressive multilayer coverage in which outer GNP layers are bound only by basal-plane to basal-plane van der Waals interactions and are therefore more readily removed under mechanical agitation than GNP platelets in direct contact with the underlying substrate.

The water-to-cement ratio (w/c) of the composite is about 0.45. In alternative embodiments, the w/c ratio may be between about 0.35 and about 0.55, depending on the desired workability, strength, and durability characteristics.

In one embodiment, six concrete mixtures are cast for the working examples disclosed herein, including one no-coating Plain Concrete control, three GNP-bearing inventive mixtures (GNP-A, CSGNP-A, and HLGNP-A), and two coating-control mixtures (CS-A and HL-A). The GNP-coated aggregates (GNP-A, CSGNP-A, or HLGNP-A) are mixed with the Type 1L Portland-limestone cement, water, and any additives using conventional concrete mixing equipment and techniques. In one embodiment, the coarse aggregate is added to the mixer first, followed by the fine aggregate, then the cement, and finally the water and admixtures. Mixing may be performed for about 3 to about 5 minutes to achieve a uniform and cohesive mixture. The fresh mixture may be cast into molds or formwork, vibrated for at least about 2 minutes to ensure adequate compaction, and cured under standard conditions (temperature of about 23 °C±2 °C; relative humidity greater than about 95%) for at least about 28 days. The composite may be prepared as cast-in-place concrete or as precast concrete panels.

Compressive strength is measured on 102 mm×203 mm concrete cylinders in accordance with ASTM C39/C39M, a standard known to those skilled in the art, at 28 days; splitting tensile strength in accordance with ASTM C496 and modulus of elasticity in accordance with ASTM C469.

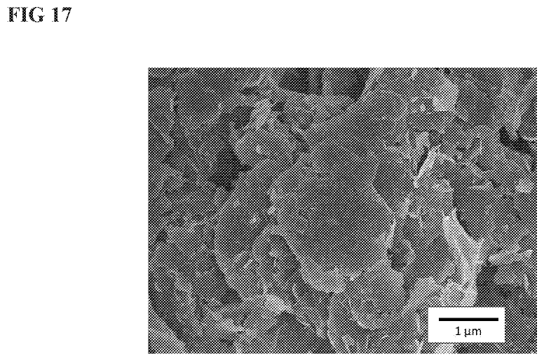

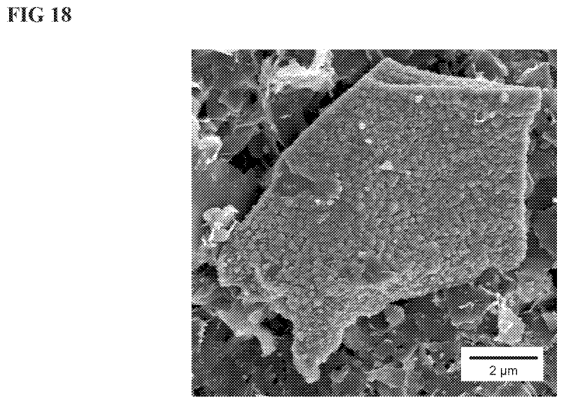

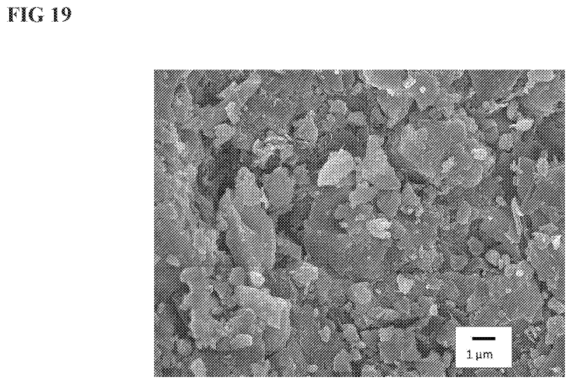

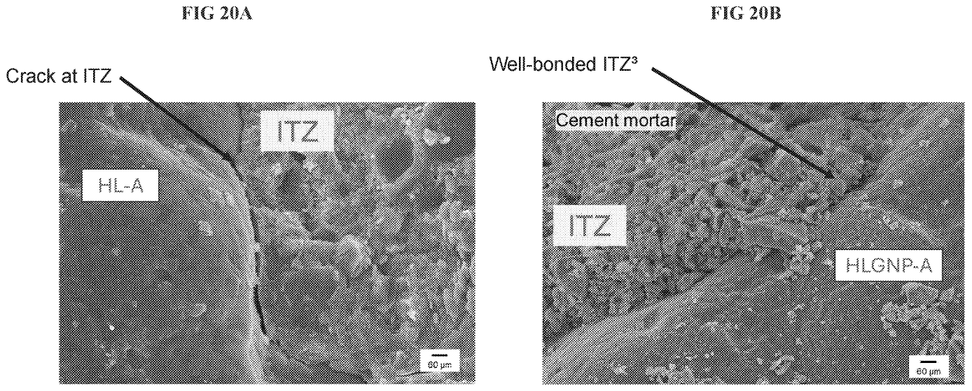

Referring to FIGS. 17-20, scanning electron microscopy (SEM) is performed on (i) control and GNP-coated aggregate particles taken from the coating process before incorporation into a concrete mix and (ii) fracture surface of hardened concrete specimen after mechanical property testing. In the inventor laboratory, the diagnostic features observed by SEM included: (a) a porous microstructure on the uncoated surface; (b) GNP platelets visibly deposited and partially overlapping on the GNP-A surface; (c) GNPs embedded within and partially covered by hydration products on the CSGNP-A surface; and (d) a denser, more uniform GNP-and-hydrate layer on the HLGNP-A surface. Cross-section SEM of fractured concrete specimens demonstrated a well-bonded ITZ for HLGNP-A and a crack-at-ITZ failure mode for the Plain Concrete control.

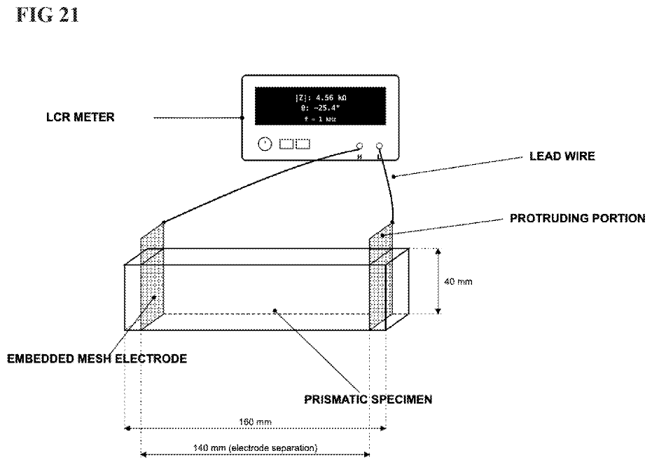

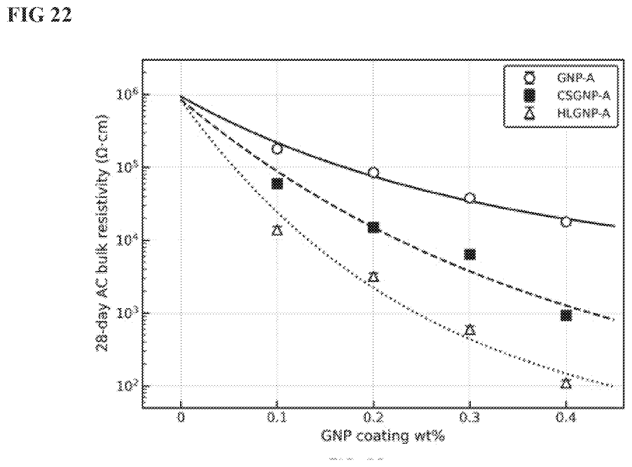

Referring to FIG. 21, electrical characterization of the cementitious composite of the present application is performed by two-electrode alternating-current (AC) electrochemical impedance spectroscopy (EIS) using the two-electrode AC EIS fixture, in which a prismatic specimen has two embedded electrodes. The measurement is conducted by application of a sinusoidal AC voltage between the two electrodes and concurrent measurement of the complex impedance Z* as a function of frequency. In one embodiment, the applied AC voltage has an amplitude of 5 V, the frequency is swept from 20 Hz to 1 MHz on a logarithmic frequency axis, the embedded electrodes are spaced apart by 140 mm, and the prismatic specimen has dimensions of 40 mm×40 mm×160 mm. The bulk AC resistivity of the cementitious composite is calculated from the impedance modulus |Z*| measured at the high-frequency cusp (in one embodiment, in a range of from approximately 50 kHz to approximately 200 kHz) and from the specimen geometry. FIG. 22 is a data plot of the AC bulk resistivity of the cementitious composite of the present application as a function of GNP shell loading on a logarithmic ordinate, with error bars representing the standard deviation of n≥3 replicates per loading point. The measured 28-day AC bulk resistivities for each coating method at GNP loadings of 0.1, 0.2, 0.3, and 0.4 wt % are shown in TABLE 5. The cementitious composite of the present application exhibits a 28-day AC bulk resistivity ranging from approximately 110 Ω·cm at 0.4 wt % HLGNP loading to approximately 1.8×10⁵ Ω·cm at 0.1 wt % GNP-A loading, versus approximately 106 Ω·cm for an uncoated-aggregate control. By concentrating the conductive phase at the aggregate surface, electron-transport pathways are localized at the aggregate-matrix interface reducing the nanomaterial dosage required to reach electrical percolation relative to bulk-paste dispersion, while also densifying the surrounding interfacial region. The aggregate-coated architecture lowers the effective percolation threshold because the GNP is concentrated at the ITZ rather than dispersed through the paste volume. The conduction mechanism is no longer dependent on bulk volume fraction but areal coverage at aggregate surfaces, and aggregate-aggregate contact through the ITZ becomes the principal conduction path.

TABLE 5
8-day AC bulk resistivity (22 cm) at the high-frequency cusp
point for GNP-A, CSGNP-A, and HLGNP-A concrete
mixtures at GNP loadings of 0.1, 0.2, 0.3, and 0.4 wt %.

| Sample | 0.1 wt % | 0.2 wt % | 0.3 wt % | 0.4 wt % |
|---|---|---|---|---|
| GNP-A | 1.8 × 10⁵ | 8.5 × 10⁴ | 3.8 × 10⁴ | 1.8 × 10⁴ |
| CSGNP-A | 6.5 × 10⁴ | 1.5 × 10⁴ | 6.4 × 10³ | 9.1 × 10² |
| HLGNP-A | 1.4 × 10⁴ | 3.2 × 10³ | 5.9 × 10² | 1.1 × 10² |

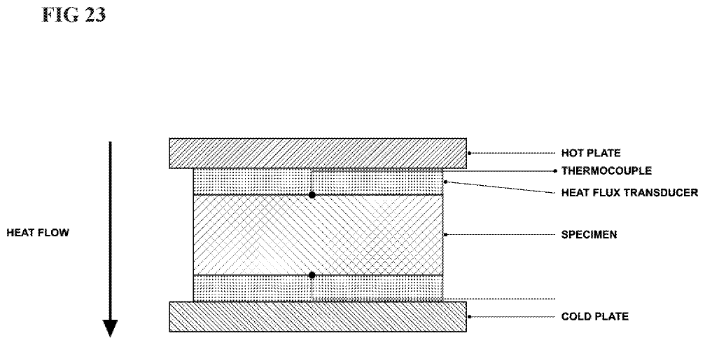

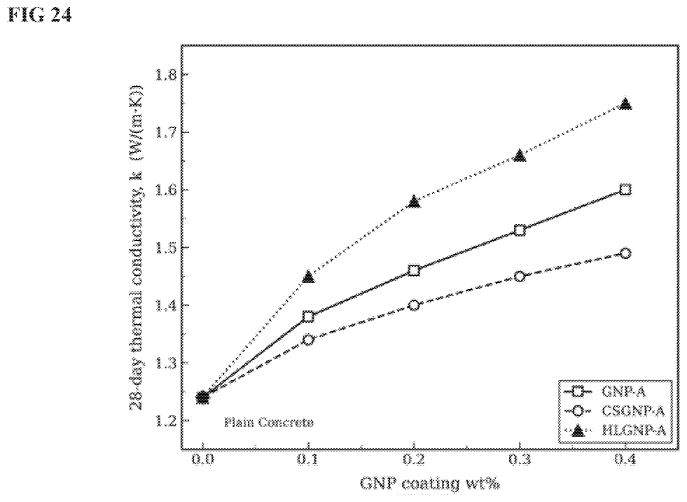

Referring to FIG. 23, thermal conductivity was measured on 203 mm×203 mm×35 mm slab specimens of each of four concrete mixtures (Plain Concrete, GNP-A, CSGNP-A, HLGNP-A) in accordance with ASTM C518, a standard known to those skilled in the art, at 28 days, at room temperature (~25 °C). FIG. 23 shows a heat flow meter apparatus configured for steady-state thermal conductivity measurement of the cementitious composite according to ASTM C518, comprising a hot plate, an upper heat flux transducer, a specimen of the cementitious composite, a lower heat flux transducer, a cold plate, and an upper surface thermocouple and a lower surface thermocouple in contact with respective upper and lower faces of the specimen. The measured thermal conductivities are presented in TABLE 6, and FIG. 24 provides a data plot of the 28-day thermal conductivity of the cementitious composite as a function of GNP shell loading at room temperature. Thermal conductivity at room temperature (~25 °C) increased systematically with GNP shell loading for all modified mixtures. The HLGNP-A mixture exhibited the highest thermal conductivity, reaching approximately 1.75 W/m K at 0.4 wt % loading, corresponding to an increase of approximately 41% relative to the control. The observed enhancement is attributed to improved solid-phase connectivity and reduced interfacial thermal resistance associated with the aggregate-coated conductive network. The specific heat capacity, also measured by the inventor laboratory on the same slab specimens, is presented in TABLE 6. Specific heat capacity measurements show a gradual decrease with increasing GNP loading for all modified mixtures, with the largest reduction observed in HLGNP-A (approximately 20% at 0.4 wt %). The combined increase in thermal conductivity and decrease in specific heat is beneficial for transient electro-thermal applications. The increase in thermal conductivity is consistent with the formation of conductive pathways at the aggregate-matrix interface, which also govern the electrical transport behavior described above.

TABLE 6
28-day thermal conductivity (W/(m · K)) and specific
heat capacity (kJ/(kg · K)) of Plain Concrete and of
GNP-A, CSGNP-A, and HLGNP-A concrete mixtures
at GNP loadings of 0.1, 0.2, 0.3, and 0.4 wt %,
measured at room temperature

| | | Thermal | Specific Heat |
|---|---|---|---|
| | | conductivity | Capacity |
| Mixture | GNP loading | (W/(m · K)) | kJ/(kg · K) |
| Plain Concrete | — | 1.24 | 0.97 |
| GNP-A | 0.1 wt % | 1.38 | 0.92 |
| | 0.2 wt % | 1.46 | 0.89 |
| | 0.3 wt % | 1.53 | 0.87 |
| | 0.4 wt % | 1.60 | 0.85 |
| CSGNP-A | 0.1 wt % | 1.34 | 0.94 |
| | 0.2 wt % | 1.40 | 0.91 |
| | 0.3 wt % | 1.45 | 0.89 |
| | 0.4 wt % | 1.49 | 0.88 |
| HLGNP-A | 0.1 wt % | 1.45 | 0.90 |
| | 0.2 wt % | 1.58 | 0.85 |
| | 0.3 wt % | 1.66 | 0.81 |
| | 0.4 wt % | 1.75 | 0.78 |

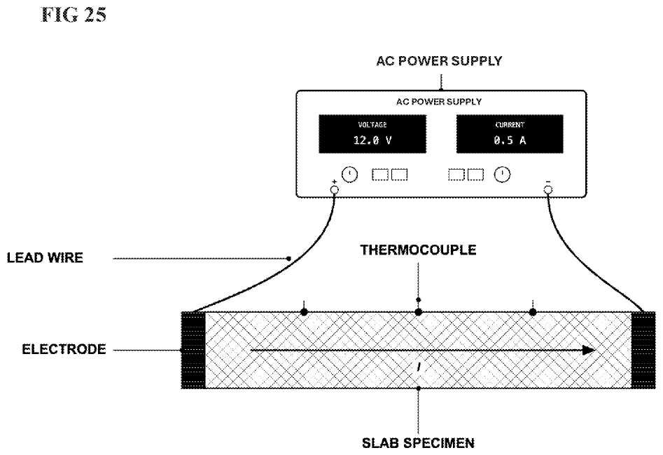

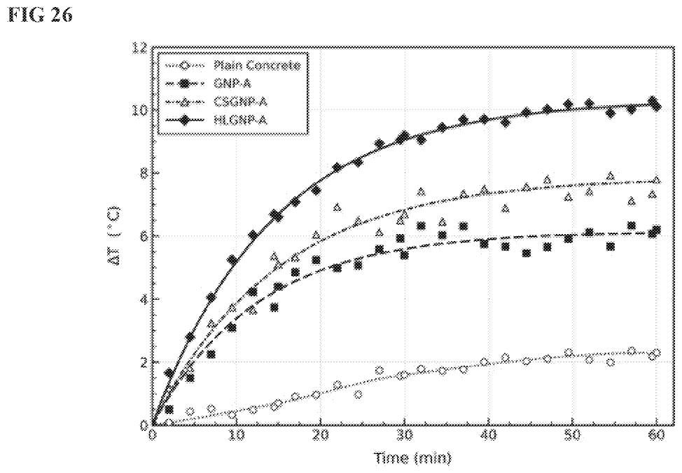

Electrothermal characterization of the cementitious composite is performed by application of an alternating-current (AC) voltage between the embedded mesh electrodes with concurrent measurement of (i) surface temperature via embedded thermocouples; (ii) current; and (iii) input power. The applied AC voltage induces Joule heating within the conductive network of the composite. FIG. 25 shows a Joule heating test apparatus for the cementitious composite, comprising a AC power supply, a first lead wire, a first electrode, a slab specimen of the cementitious composite, a second electrode, a second lead wire, and a plurality of surface thermocouples in contact with an upper surface of the slab specimen. In one embodiment, a low-frequency AC voltage is applied across the electrodes, and the resulting current is measured to determine the electrical power input. The magnitude of the applied voltage is selected based on the bulk resistivity of the composite and specimen geometry to achieve a target power density. Measured surface temperature rise (ΔT) at 15, 30, and 60 minutes for Plain Concrete, GNP-A, CSGNP-A, and HLGNP-A under a 5 V AC bias is set forth in TABLE 7. For cementitious composites exhibiting bulk resistivity in the range of approximately 150 to 1000 52 cm, the applied AC voltage is typically in the range of 5 to 30 V, resulting in current levels on the order of 0.2 to 2 A. Under these conditions, the resulting power density is generally in the range of approximately 0.1 to 1.0 kW/m², producing a measurable surface temperature increase. For the compositions described herein, the surface temperature rise is typically on the order of 5 to 15 °C above ambient under steady-state conditions. The thermal response is governed by the coupled electrical and thermal properties of the composite. Compositions exhibiting reduced resistivity, increased thermal conductivity (approximately 1.3 to 1.75 W/m K), and reduced specific heat capacity (approximately 0.78 to 0.97 KJ/(kg·K)) demonstrate improved heating efficiency and faster thermal response relative to conventional concrete. FIG. 26 shows a data plot of the surface temperature increase of the cementitious composite as a function of time under a constant applied AC voltage.

TABLE 7
28-day surface temperature increase (ΔT, °C ± 16) of
Plain Concrete, GNP-A, CSGNP-A, and HLGNP-A
slab specimens at 15, 30, and 60 minutes under a
constant 5 V AC bias at room temperature

| | ΔT at 15 min | ΔT at 30 min | ΔT at 60 min |
|---|---|---|---|
| Plain Concrete | 0.7 °C ± 0.5 | 1.6 °C ± 0.6 | 2.3 °C ± 0.6 |
| GNP-A | 4.5 °C ± 0.4 | 5.5 °C ± 0.3 | 6.2 °C ± 0.4 |
| CSGNP-A | 5.7 °C ± 0.3 | 7.1 °C ± 0.4 | 7.7 °C ± 0.4 |
| HLGNP-A | 6.7 °C ± 0.2 | 9.2 °C ± 0.3 | 10.1 °C ± 0.3 |

In optional embodiments, the cementitious composite may further include macroscale conductive components distributed in the cementitious matrix. The macroscale components are greater than 1000 nanometers in smallest dimension (e.g., thickness or diameter). When dispersed in the cementitious matrix, the macroscale fibers may form a continuous conductive network throughout the composite that bridges the GNP-coated aggregates, providing additional macroscale conductive pathways and structural reinforcement. The macroscale components contribute to improved mechanical strength, thereby improving the pavement's ability to withstand traffic loads and environmental stress, while simultaneously maintaining effective conductivity for electrothermal functionalities. The macroscale fibers may have a length of about 3 mm to about 25 mm, a diameter of about 5 micrometers to about 15 micrometers, and an electrical conductivity along the fiber axis of greater than approximately 104 S/m. In one embodiment, the chopped carbon fiber is present in the cementitious composite at a dosage in a range of from approximately 0.1 vol % to approximately 1.0 vol % of the cementitious composite. However, it will be appreciated that the primary embodiment of the present disclosure achieves enhanced electrical and thermal conductivity through the GNP-coated aggregates without the addition of macroscale fibers.

The cementitious composite may further include one or more additives to improve workability, fiber dispersion (where fibers are used), air entrainment, or conductivity. The additives may include a water-reducing admixture (e.g., polycarboxylate-based superplasticizer), an air-entraining admixture, a viscosity-modifying admixture, a set retarder, a conductivity-enhancing admixture (e.g., calcium nitrite or aqueous solutions of compounds of alkali and alkaline earth metals), a fiber-dispersive agent (e.g., methyl cellulose), and combinations thereof. The dosage of superplasticizer may be in accordance with the manufacturer's recommendations for the cement type and desired workability.

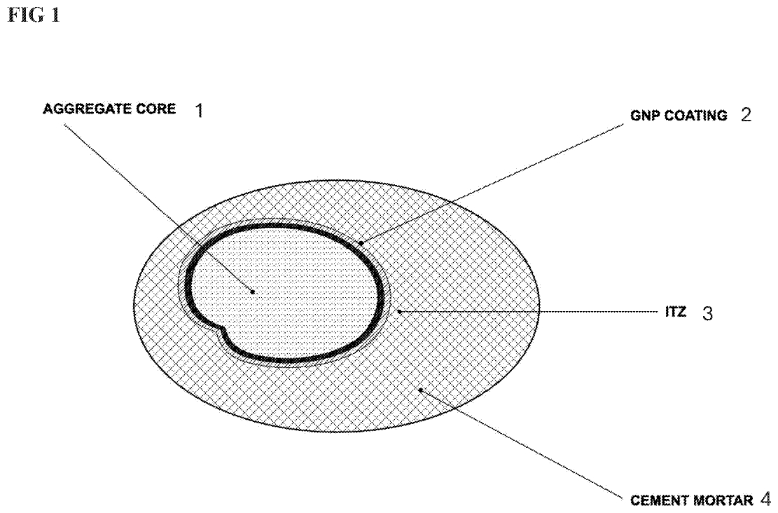

Referring to FIG. 1, a cross-sectional view of a single GNP-coated aggregate grain or particle embedded in a cement mortar matrix according to an example is shown, comprising an aggregate core 1, a GNP coating layer 2 disposed on a surface of the aggregate core 1, an ITZ 3 formed between the GNP coating layer and a cement mortar matrix 4, and the cement mortar matrix surrounding the GNP-coated aggregate grain.

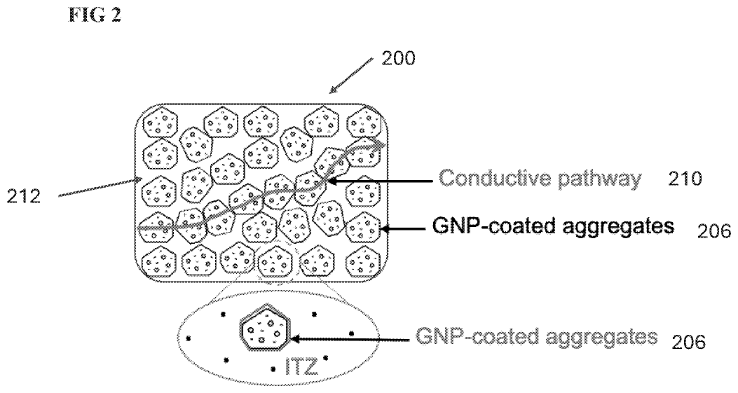

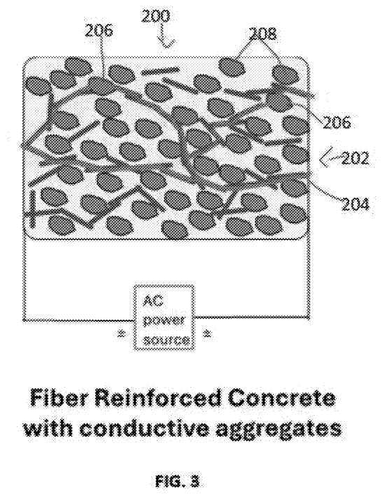

A key feature resides in the architectural placement of the conductive coating at the aggregate-paste interface, rather than in bulk dispersion of a conductive phase throughout the cementitious matrix. The percolating conductive network of the cementitious composite of the present application is established principally by contact between the GNP shells on adjacent GNP-coated fine and coarse aggregate particles through the densified ITZ. In one embodiment, the percolating conductive network is supplemented by an optional macroscale conductive fiber, that is dispersed in the cementitious matrix and that bridges adjacent GNP-coated fine and coarse aggregate particles to provide a continuous conductive pathway through the hardened cementitious composite. FIG. 2 illustrates an example of a conductive concrete composite or hardened cementitious composite 200 where the conductive pathway 210 is formed principally by contact between adjacent GNP-coated aggregates 206. FIG. 3 illustrates a schematic cross-section of the cementitious composite 200 of the present application, showing the GNP-coated fine and coarse aggregate 206, the cement paste matrix, the densified ITZ, and an optional macroscale conductive carbon fiber 204 dispersed in the matrix. The macroscale conductive fiber 204 facilitates formation of the conductive pathway 210. Because the macroscale conductive fiber is optional in the present application, the percolating conductive network is supported by the GNP shell architecture alone in the absence of the macroscale conductive fiber and is supplemented by the macroscale conductive fiber when present.

The electrothermal cementitious composite may be incorporated into a full-scale pavement system, such as roadways for vehicles, sidewalks, bridge surfaces, parking lots, and driveways. The electrothermal cementitious composite may form the top layer of a pavement structure, or may be retrofitted to existing pavement systems as an overlay on top of traditional concrete (e.g., existing roads), making it a cost-effective and scalable solution for municipalities. The retrofitted approach allows for older infrastructure to benefit from advanced electrothermal properties without requiring a complete replacement of existing roadways. While urban is used herein to denote city environments, it will be appreciated that the electrothermal concrete pavement system may be used in townships or rural environments without departing from the scope of the disclosure.

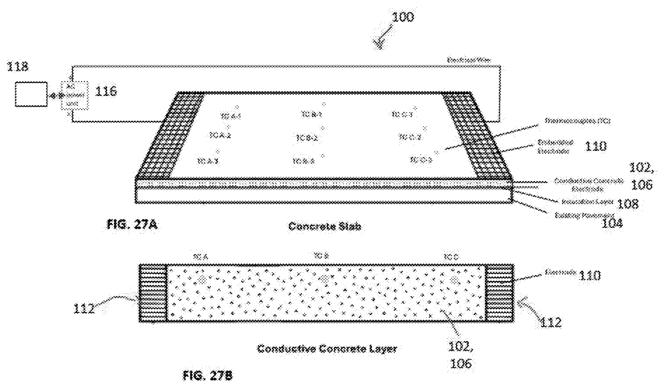

Referring to FIG. 27A, a conductive concrete pavement system 100 is shown. The system 100 shown in FIG. 27A is an existing pavement system retrofitted with a surface layer of the disclosed cementitious composite (also referred to as conductive concrete or electrothermal concrete) 102. It will be appreciated, however, the cementitious composite 102 may replace the existing pavement without departing from the scope of the disclosure. The conductive concrete 102 is laid over the existing pavement 104 as a surface layer 106, with an electrical insulation layer 108 disposed between the existing pavement 104 and the conductive concrete 102 to help prevent leaching of electricity to existing concrete. The conductive concrete 102 comprises a cement base, e.g., Type 1L cement, with aggregates coated with graphene nanoplatelets (GNPs), and optionally including macroscale carbon fibers.

The cementitious composite disclosed herein is incorporated, in one embodiment, into an electrothermal pavement system suitable for outdoor deicing service. The conductive concrete layer 102, 106 has embedded electrodes 110 (e.g., first and second electrodes) that may be placed at longitudinal ends 112 of the concrete slab, and a power source 116 (e.g., AC power unit, solar power unit, etc.) may apply voltage to the electrodes 110 to supply electricity (e.g., the power source 116 is operatively connected to the electrodes 110 to apply a voltage across the concrete slab). The conductive components form a continuous conductive network throughout the concrete, heating the concrete to remove snow and ice. The conductive concrete pavement system 100 further includes a controller 118 operatively connected to the power source 116 for managing energy consumption and controlling the electrothermal operation. In some aspects, a plurality of thermocouples (TC A, TC B, TC C, etc.) may be arranged throughout the cementitious composite 102 to monitor temperature distribution across the concrete slab 114.

The controller 118 may be operatively connected (e.g., via wires or wireless) to the voltage source 116 and/or sensors (TC A, TC B, TC C) to monitor/control temperature and energy usage. The controller 118 may be programmed or configured for energy-efficient operation and automated deicing/snow removal. For example, the controller 118 may use feedback from the thermocouples TC A, TC B, TC C and power source 116 to determine weather conditions (e.g., snow or ice on the roadway), temperature of the concrete, and/or energy usage, e.g., to turn the system 100 on or off as appropriate. Additionally, the controller 118 may be connected to external servers or the internet to receive information on real-time weather status (e.g., incoming or current snowy/icy conditions). The integration of smart technologies (e.g., a computer or other processor with memory that controls energy consumption) into the pavement system represents a significant step forward in urban infrastructure innovation, particularly in colder climates. The smart concrete system offers energy-efficiency gains, improved safety, lower environmental impact, and reduced operational costs compared to traditional snow and ice removal methods. The energy efficiency of the system is a critical consideration. The invention optimizes the balance between energy consumption and conductive performance. The disclosed technology ensures that the conductive concrete system operates effectively without excessively high energy demands, making the cementitious composite a viable solution for urban infrastructure. In addition to material advancements with nanoengineered cementitious composite, optionally together with macroscale components for a hybrid approach, this invention also integrates an external control system that can automate the energy management for the conductive pavement, ensuring optimized snow and ice removal while preventing energy waste.

FIG. 27B shows a schematic top view of a conductive concrete layer 102, 106 of FIG. 27A. The cementitious composite 102 includes embedded electrodes 110 positioned at opposing ends of the conductive concrete layer 106. Thermocouples TC A, TC B, TC C are distributed within the cementitious composite 102 for temperature monitoring during electrothermal operation. The conductive concrete layer 106 contains distributed conductively coated aggregates (e.g., fine and coarse aggregates coated with GNPs) throughout the cementitious composite 102 that form conductive pathways between the embedded electrodes 110. When voltage is applied from the power source 116, resistive heating is enabled through the conductive pathways, generating heat to melt snow and ice on the pavement surface. In this embodiment, the percolating conductive network is established principally by GNP-shell-to-GNP-shell contact between adjacent coated fine and coarse aggregate particles through the densified ITZ, and is optionally supplemented by the macroscale conductive fiber. The macroscale conductive carbon fiber used in this Example was PAN-based chopped carbon fiber; commercially available high-modulus conductive grade; with a fiber length of 12 mm, a fiber diameter of 7 μm, an aspect ratio of approximately 1700, a tensile strength of 3.5-4.5 GPa, a Young's modulus of 230-250 GPa, and an electrical conductivity along the fiber axis of approximately 5×10⁴ to 1×10⁵ S/m. The carbon fiber was added at a dosage of 0.25 vol % of the cementitious composite and was dispersed by dry pre-blending with sand and coated aggregate prior to water addition, followed by high-intensity mixing. Operating parameters and measured performance of the 1 m×1 m laboratory-scale slab demonstration are set forth in TABLE 8.

TABLE 8
Operating parameters and 28-day measured performance of the 1 m × 1 m
laboratory-scale conductive pavement slab (HLGNP-A-CF)

| Slab size | 1 m × 1 m | |
|---|---|---|
| Conductive top layer thickness | 90 | mm |
| Plain Concrete bottom layer thickness | 90 | mm |
| Electrode spacing | 800 | mm |
| Applied voltage | 30 | V |
| Power density | 0.1-0.35 | kW/m² |
| Surface temperature rise | 9.2 | °C |
| Time to near-equilibrium | 180 | min |

### Exemplary Conductive Concrete Composites

Referring back to FIGS. 2 and 3, exemplary conductive concrete composites 200 are shown. FIG. 2 schematically illustrates a cross-section of a hardened cementitious composite 200 according to one or more embodiments of the present invention. A plurality of coated aggregate particles 206, depicted as polygonal cross-sections, is dispersed in a continuous cementitious matrix 212. Each aggregate particle bears a graphene nanoplatelet (GNP) coating, depicted by the discrete filled markings distributed at and adjacent to the periphery of each polygon. The coating or film may be, for example, in the nanometer range such as less than 1000 nanometers (nm). It will be appreciated, however, that some of the aggregate particles in the composite 200 may be uncoated without departing from the scope of the disclosure. The dashed circumferential boundary indicated on a representative coated aggregate denotes the interfacial transition zone (ITZ), that is, the thin region of hydrated cement paste immediately adjacent to the aggregate surface, which under the present coating architecture is enriched with the GNP phase relative to the bulk matrix. Because the GNP coating is anchored at the aggregate surface, the ITZs of adjacent coated aggregates contain a continuous GNP phase at their shared boundaries throughout the composite 200, thereby forming a percolation network that provides one or more continuous conductive pathways 210 (e.g., forming a conductive pathway between electrodes when voltage is applied). A representative conduction pathway 210 through this percolation network is illustrated by the meandering arrowed line, which passes from one face of the composite, through successive GNP-enriched ITZ regions of adjacent coated aggregates 206, and exits the opposing face. The expanded callout below the cross-section depicts a single GNP-coated aggregate 206 at higher magnification, showing the aggregate substrate and the discrete graphene nanoplatelets at and adjacent to the substrate surface. FIG. 2 illustrates that the inventive architecture localizes the conductive GNP phase at the ITZ, where it is effective in establishing a continuous percolation pathway at low total GNP loading, in contrast to the conventional approach of bulk-admixing GNPs into the matrix at substantially higher loadings to achieve comparable connectivity. FIG. 3 illustrates an example of fiber reinforced concrete 202 with conductive macroscale fibers 204 together with conductively coated aggregates 206 forming a continuous conductive network 210 throughout the concrete layer that creates an integrated heating system when a voltage is applied (e.g., from the power source). The conductively coated aggregates 206 are dispersed within the fiber reinforced concrete 202 and include a conductive coating on their surfaces. Uncoated aggregates 208 may also be present within the fiber reinforced concrete 202. The macroscale fiber 204 extends between and around both the conductively coated aggregates 206 and the uncoated aggregates 208, creating interconnections throughout the conductive concrete composite 200. The conductive coating comprises graphene nanoplatelets (GNPs) that form a coating or film around the aggregate (e.g., the individual aggregate material). The coating or film may be, for example, in the nanometer range such as less than 1000 nanometers (nm). The macrofibers 204 function as connecting elements (connectors) between the conductively coated aggregates, in addition to forming a continuous conductive pathway between the electrodes. In both examples, a power source may be connected to the conductive concrete composite 200 at opposing sides (e.g., to electrodes) to provide electrical current through the material.

The GNPs may be present at a dosage of up to about 0.4% by weight of cement, for example at dosages of 0.1% to 0.4% by weight of cement. This dosage range avoids agglomeration problems associated with bulk dispersion in the highly alkaline cement matrix.

### Methods for Coating Aggregates and Preparing A Conductive Cementitious Composite

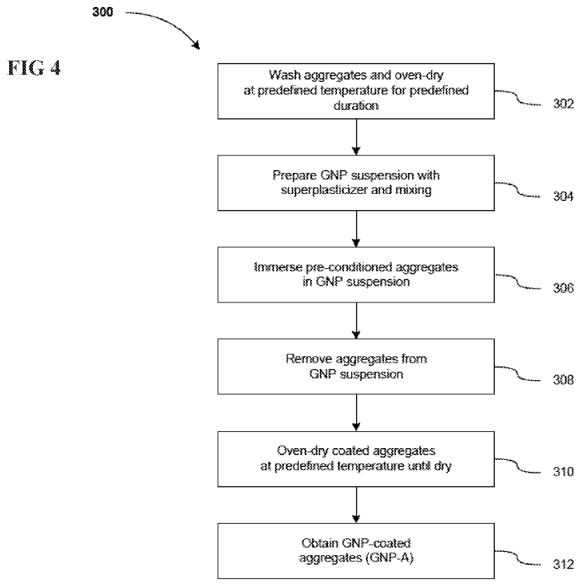

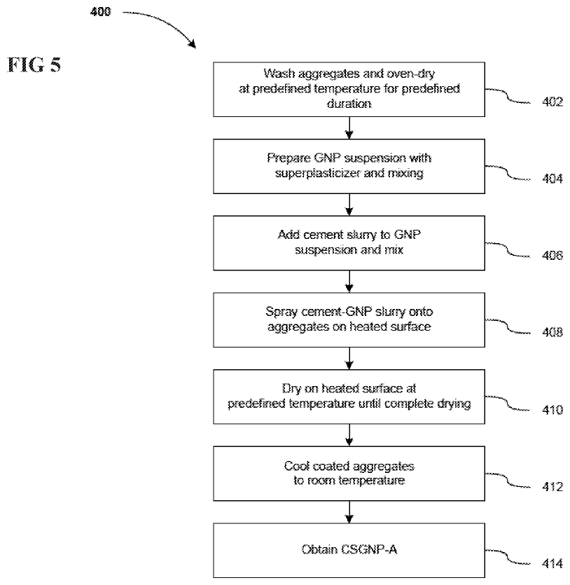

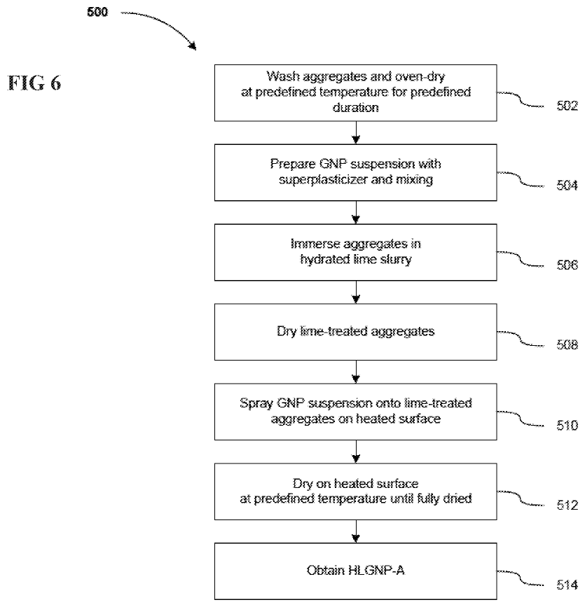

FIG. 4-6 illustrate methods for coating the aggregates (e.g., fine and/or coarse) with GNPs (to form conductively coated aggregates), each producing modified aggregates with GNP-enhanced surfaces that refine the ITZ upon mixing with cement. FIG. 4 illustrates GNP-coated aggregates (“GNP-A”), FIG. 5 illustrates cement slurry and GNP hybrid coated aggregates (“CSGNP-A”), and FIG. 6 illustrates hydrated lime and GNP hybrid coated aggregates (“HLGNP-A”).

Referring to FIG. 4, a method 300 of preparing GNP-coated aggregates (GNP-A) is shown. The method 300 includes a step 302 of washing aggregates and oven-drying at a predefined temperature (e.g., approximately 105 °C) for a predefined duration (e.g., approximately 24 hours) to remove surface moisture and contaminants. A step 304 involves preparing an aqueous dispersion (e.g., GNP suspension) with a superplasticizer and ultrasonication to achieve a stable, well-dispersed suspension. A step 306 involves immersing the pre-conditioned aggregates in the GNP suspension to allow adsorption of GNPs onto the aggregate surfaces. The immersion time may be from about 30 minutes, and the GNPs adsorb onto the aggregate surfaces through physical entrapment in the surface microtexture of the aggregate particles. A step 308 involves removing the aggregates from the GNP suspension. A step 310 involves drying (e.g., oven-drying) the coated aggregates at a predefined temperate (e.g., about 60-80 °C) until dry. A step 312 involves obtaining the resulting GNP-coated aggregates (GNP-A).

Referring to FIG. 5, a method 400 of preparing cement slurry and GNP hybrid coated aggregates (CSGNP-A) is shown. The method 400 includes a step 402 of washing aggregates and oven-drying at a predefined temperature (e.g., approximately 105 °C) for a predefined duration (e.g., approximately 24 hours) to remove surface moisture and contaminants. A step 404 involves preparing an aqueous dispersion (e.g., GNP suspension) with a superplasticizer and ultrasonication to achieve a stable, well-dispersed suspension. A step 406 involves adding cement slurry (e.g., Type 1L cement) to the GNP suspension and mixing to obtain a homogeneous cement-GNP slurry. The cement slurry is added to the GNP suspension at a ratio of about 5 grams per 100 cm³ of suspension. A step 408 involves spraying the cement-GNP slurry onto oven-dried aggregates placed on a heated surface. A step 410 involves drying on the heated surface at 60-120 °C until complete drying is achieved. Pursuant to an example, the heated surface may be maintained at a temperature of about 60 °C, to promote rapid evaporation of the water carrier and adhesion of the cement-GNP layer to the aggregate surface. A step 412 involves cooling the coated aggregates to room temperature. Step 412 may be performed after complete drying of the cement-GNP layer. A step 414 involves obtaining the resulting cement slurry and GNP hybrid coated aggregates (CSGNP-A).

Referring to FIG. 6, a method 500 of preparing hydrated lime and GNP hybrid coated aggregates (HLGNP-A) is shown. The method 500 includes a step 502 of washing aggregates and oven-drying at a predefined temperature (e.g., approximately 105 °C) for a predefined duration (e.g., approximately 24 hours) to remove surface moisture and contaminants. A step 504 involves preparing an aqueous dispersion (e.g., GNP suspension) with a superplasticizer and ultrasonication to achieve a stable, well-dispersed suspension. A step 506 involves immersing the oven-dried aggregates in a hydrated lime (calcium hydroxide, Ca(OH)₂) slurry. The hydrated lime may have a concentration of about 1 gram to about 20 grams of hydrated lime per 100 cm³ of water. A step 508 involves drying the lime-treated aggregates, e.g., by placing the lime-treated aggregates on a heated surface. A step 510 involves spraying the GNP suspension onto the lime-treated aggregates that are placed on the heated surface, wherein the heated surface may be maintained at a temperature of about 60 °C. According to an example, steps 508 and 510 may be performed simultaneously or in a single step. A step 512 involves drying the coated aggregates on the heated surface at approximately 60 °C until fully dried to ensure adhesion of the GNP coating onto the lime-treated surface. That is, the aggregates may be kept under heat (e.g., at approximately 60 °C) during steps 508-512 until fully dried to ensure complete adhesion of the conductive coating. A step 514 involves obtaining the resulting hydrated lime and GNP hybrid coated aggregates (HLGNP-A).

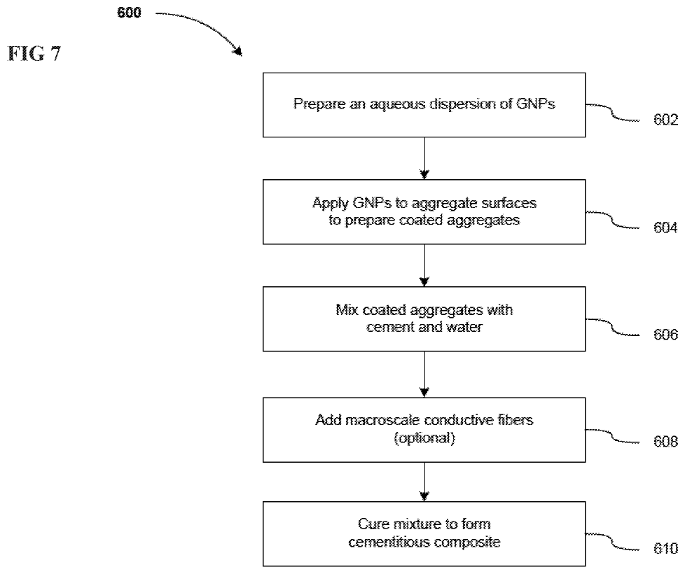

Referring to FIG. 7, a method 600 of preparing a conductive cementitious composite is shown. The method 600 includes a step 602 of preparing an aqueous dispersion of GNPs (e.g., GNP suspension). A step 604 involves applying GNPs to surfaces of the aggregates to prepare conductively coated aggregates. Step 604 may include method 300, 400, and/or 500. A step 606 involves mixing the conductively coated aggregates with cement and water to form a mixture. A step 608 involves an optional step of adding macroscale conductive fibers to form a conductive network bridging the conductively coated aggregates. A step 610 involves curing the mixture to form the cementitious composite, wherein the GNPs are positioned at an interfacial transition zone between the aggregates and a cementitious matrix of the cementitious composite.

Accordingly, a method of preparing a cementitious composite may include: preparing conductively coated aggregates by applying graphene nanoplatelets (GNPs) to surfaces of aggregates; mixing the conductively coated aggregates with a cementitious material and water to form a mixture and curing the mixture to form the cementitious composite, wherein the GNPs are positioned at an interfacial transition zone between the aggregates and a cementitious matrix of the cementitious composite. Pursuant to an implementation, preparing the conductively coated aggregates comprises immersing fine and/or coarse aggregates in an aqueous dispersion of GNPs to pre-adsorb the GNPs onto the surfaces of the aggregates. Additionally or alternatively, mixing further comprises adding macroscale conductive fibers to form a conductive network bridging the conductively coated aggregates.

### EXAMPLES

### Example 1: Preparation of GNP-Coated Aggregate by Direct Immersion (GNP-A)

Limestone aggregate was washed in deionized water, oven-dried at 105±5 °C to constant mass, and then immersed in a GNP suspension. The coated aggregate was drained and oven-dried until constant mass was reached. The procedure was carried out at GNP loadings of 0.1, 0.2, 0.3, and 0.4 wt %. The water absorption of the resulting GNP-A at 0.1 wt %, in accordance with ASTM C127, a standard known to those skilled in the art, was 0.97%, versus 1.23% for the uncoated aggregate. The shell retention index (SRI) of GNP-A, quantified by the difference in the 300 °C to 425 °C TGA mass-loss step before and after a mechanical-agitation rinse protocol, was 38.5% at 0.1 wt %, 36.0% at 0.2 wt %, 29.0% at 0.3 wt %, and 25.0% at 0.4 wt %, as set forth in TABLE 4. The GNP-A coated aggregate prepared at 0.1 wt % was incorporated into a concrete batch to produce concrete Mixture GNP-A. The 28-day compressive strength of Mixture GNP-A, in accordance with ASTM C39/C39M, was 50.2 MPa, an increase of approximately 16% relative to the Plain Concrete control (43.2 MPa).

### Example 2: Preparation of GNP-Coated Aggregate by Cement-Slurry Coating (CSGNP-A)

Pretreated limestone aggregate (coarse, fine, or a combination thereof) was sprayed with a thin GNP-Type 1L Portland cement slurry. The coated aggregate was drained and oven-dried. The procedure was carried out at GNP loadings of 0.1, 0.2, 0.3, and 0.4 wt % relative to the cement mass in the slurry. The water absorption of the resulting CSGNP-A at 0.1 wt %, in accordance with ASTM C127, was reduced to 0.72%, the lowest value among the three methods. The SRI of CSGNP-A was 71.0% at 0.1 wt %, 68.0% at 0.2 wt %, 64.0% at 0.3 wt %, and 60.0% at 0.4 wt %, as set forth in TABLE 4. The CSGNP-A coated aggregate prepared at 0.1 wt % was incorporated into a concrete batch to produce concrete Mixture CSGNP-A. The 28-day compressive strength of Mixture CSGNP-A, in accordance with ASTM C39/C39M, was 49.7 MPa, an increase of approximately 15% relative to the Plain Concrete control. A companion control mixture without GNP was prepared in accordance with the same procedure with omission of the GNP component and is designated CS-A.

### Example 3: Preparation of GNP-Coated Aggregate by Hydrated-Lime Hybrid Coating (HLGNP-A)

Pretreated limestone aggregate (coarse, fine, or a combination thereof) was first immersed in hydrated lime, in accordance with ASTM C207, a standard known to those skilled in the art, and was then immersed in the GNP suspension. The coated aggregate was drained and oven-dried. The procedure was carried out at GNP loadings of 0.1, 0.2, 0.3, and 0.4 wt %. The water absorption of the resulting HLGNP-A at 0.1 wt % was 0.92%. The SRI of HLGNP-A was 82.5% at 0.1 wt %, 80.5% at 0.2 wt %, 78.0% at 0.3 wt %, and 75.5% at 0.4 wt %, as set forth in TABLE 4; the SRI of HLGNP-A was the highest among the three methods at every GNP loading tested. The HLGNP-A coated aggregate prepared at 0.1 wt % was incorporated into a concrete batch to produce concrete Mixture HLGNP-A. The 28-day compressive strength of Mixture HLGNP-A, in accordance with ASTM C39/C39M, was 58.6 MPa, an increase of approximately 35% relative to the Plain Concrete control. HLGNP-A produced the highest 28-day compressive strength among all six mixtures. A companion control mixture without GNP was prepared in accordance with the same procedure with omission of the GNP component and is designated HL-A. HLGNP-A is identified herein as the preferred embodiment of the present application on the basis of the measured retention, mechanical, and thermal results disclosed herein.

### Example 4:28-Day Compressive Strength of the GNP-Coated Aggregate Mixes

The 28-day compressive strength of each of the six concrete mixtures of was measured on 102 mm×203 mm concrete cylinders in accordance with ASTM C39/C39M, a standard known to those skilled in the art, and is presented in TABLE 9. The deconvolution between the coating-control mixtures (CS-A, HL-A) and the GNP-bearing mixtures (CSGNP-A, HLGNP-A) establishes the GNP contribution unambiguously. The cement-slurry control (CS-A) by itself yielded a +4% improvement; the addition of GNP to the cement-slurry coating brought the improvement to +15%, of which approximately 11 percentage points is attributable to the GNP. The hydrated-lime control (HL-A) by itself yielded a +7% improvement; the addition of GNP to the hydrated-lime coating brought the improvement to +35%, of which approximately 28 percentage points is attributable to the GNP. Such results indicate that the HLGNP-A architecture exhibited a measurable synergistic effect between the Ca(OH)₂ underlayer and the GNP shell.

TABLE 9
28-day compressive strength of Plain Concrete, the three coating-
control mixtures (CS-A, HL-A) and three GNP-bearing mixtures
(GNP-A, CSGNP-A, HLGNP-A), measured per ASTM C39/C39M,
and the percent change relative to the Plain Concrete control.

| | 28-day | Change vs. Plain |
|---|---|---|
| | strength | Concrete |
| Mixture | (MPa) | (%) |
| Plain Concrete | 43.2 | baseline |
| GNP-A | 50.2 | +16 |
| CS-A (cement-slurry control) | 44.9 | +4 |
| CSGNP-A | 49.7 | +15 |
| HL-A (hydrated-lime control) | 46.3 | +7 |
| HLGNP-A | 58.6 | +35 |

### Example 5: Thermal Conductivity and Specific Heat of the GNP-Coated Aggregate Mixes

The thermal conductivity and the specific heat capacity of each of four concrete mixtures (Plain Concrete, GNP-A, CSGNP-A, HLGNP-A) were measured on 203 mm×203 mm×35 mm slab specimens in accordance with ASTM C518, a standard known to those skilled in the art, at 28 days. The measured thermal conductivity and specific heat capacity are presented in TABLE 6. HLGNP-A reached a thermal conductivity of 1.45 W/(m·K) versus 1.24 W/(m·K) for Plain Concrete, at a GNP loading of 0.10 wt % of cement. HLGNP-A specific heat measured 0.90 KJ/(kg·K), −7% versus Plain Concrete. The reduced specific heat lowers the time-to-thermal-equilibrium for a given input power and is favorable for deicing service in which a rapid surface-temperature rise is desired.

### Example 6: Lab Large-Scale Slab Demonstration

A cementitious composite according to the present application was prepared by incorporating GNP-coated fine and of one or more of Methods 1, 2, and 3 into a concrete batch and further incorporating an optional macroscale conductive carbon fiber. The macroscale conductive carbon fiber used in this Example was PAN-based chopped carbon fiber with a nominal fiber length of approximately 12 mm, a nominal fiber diameter of approximately 7 μm, an aspect ratio of approximately 1700, a tensile strength of approximately 3.5-4.5 GPa, a Young's modulus of approximately 230-250 GPa, and an electrical conductivity along the fiber axis of approximately 5×10⁴ to 1×10⁵ S/m. The carbon fiber was added to the cementitious composite at a dosage of approximately 0.25 vol % of the composite and was dispersed by dry pre-blending with fine aggregate and GNP-coated aggregate prior to water addition, followed by high-intensity mixing.

TABLE 10
Composition and 28-day measured properties of mixture HLGNP-A-CF,
an HLGNP-A composite (0.30 wt % GNP) with 0.25 vol % PAN-based
macroscale chopped carbon fiber.

| Property | Measured value |
|---|---|
| Mixture identifier | HLGNP-A-CF |
| GNP shell coating method | Method 3 |
| GNP loading (wt % of cement) | 0.30 wt % |
| Macroscale conductive carbon fiber dosage | 0.25 |
| (vol % of composite) | |
| Slump (mm) per ASTM C143 | 80-100 |
| 28-day compressive strength (MPa) | 54.3 |
| 28-day AC bulk resistivity (Ω · cm) | 110 |
| Thermal conductivity (W/(m · K)) | 1.93 |
| Specific heat capacity (kJ/(kg · K)) | 0.76 |
| Steady-state surface temperature (°C) | 9.8 °C above |
| at 30 V AC | ambient |
| Time-to-thermal-equilibrium (min) | 180 |

In one embodiment, a 1 m×1 m laboratory-scale slab includes a 90 mm electrically conductive upper layer and a 90 mm nonconductive lower support layer. Embedded mesh electrodes are positioned near opposing ends of the conductive layer with an electrode spacing of approximately 0.8 m. A controlled AC voltage of approximately 30 V is applied between the electrodes. For mixtures incorporating both GNP-coated aggregates and macroscale conductive carbon fibers, the effective AC bulk resistivity is reduced to approximately 25-100 22·cm, preferably approximately 40-70 2 cm. At this resistivity range, the applied voltage produces a current of approximately 3 to 10 A and a power input of approximately 100 to 350 W, corresponding to a power density of approximately 0.10 to 0.35 kW/m² over the 1 m² slab surface. Under these conditions, the conductive layer is expected to produce a surface temperature rise of approximately 5 to 10 °C above ambient within approximately 90-180 min, depending on ambient conditions, electrode contact resistance, and heat loss to the environment and underlying nonconductive layer.

### Applications

The disclosed cement composite composition improves the existing use of concrete in road construction by incorporating electrothermal functionality for snow and ice removal. The disclosed composition may provide automated deicing capabilities, reducing the need for deicing chemicals and mechanical removal, thus enhancing road safety and mobility during winter in urban environments. The disclosed cement composite composition may be used on roads, sidewalks, bridges, driveways, parking lots, etc., particularly in urban environments that experience winter-like conditions (e.g., snow and ice accumulation), and provides improvements with snow and ice removal. The disclosed cement composite composition demonstrates the same or nearly the same mechanical properties such as strength and longevity as traditional concrete, with improvements associated with enhanced electrical and thermal conductivity for electrothermal applications.

### Controller

It should be understood that the controller as described herein may include a conventional processing apparatus known in the art, which may be capable of executing preprogrammed instructions stored in an associated memory, all performing in accordance with the functionality described herein. The controller may be configured to perform various functions, including those described in greater detail herein, with appropriate programming instructions and/or code embodied in software, hardware, and/or other medium. To the extent that the methods described herein are embodied in software, the resulting software can be stored in an associated memory and can also constitute means for performing such methods. Such a system or processor may further be of the type having ROM, RAM, and/or a combination of non-volatile and volatile memory so that any software may be stored and yet allow storage and processing of dynamically produced data and/or signals.

It will be appreciated that the computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified herein.

The non-transitory computer-readable media includes all types of computer-readable media, including magnetic storage media, optical storage media, and solid-state storage media and specifically excludes signals. It should be understood that the software can be installed in and sold with the device. Alternatively, the software can be obtained and loaded into the device, including obtaining the software via a disc medium or from any manner of network or distribution system, including, for example, from a server owned by the software creator or from a server not owned but used by the software creator. The software can be stored on a server for distribution over the Internet, for example.

Computer-readable storage media (medium) exclude (excludes) propagated signals per se, can be accessed by a computer and/or processor(s), and include volatile and non-volatile internal and/or external media that is removable and/or non-removable. For the computer, the various types of storage media accommodate the storage of data in any suitable digital format. It should be appreciated by those skilled in the art that other types of computer readable medium can be employed such as zip drives, solid state drives, magnetic tape, flash memory cards, flash drives, cartridges, and the like, for storing computer executable instructions for performing the novel methods (acts) of the disclosed architecture.

### Interpretation and Scope

When introducing elements of various embodiments of the disclosed materials, the articles “a”, “an”, “the,” and “said” are intended to mean that there are one or more of the elements. The terms “comprising,” “including,” and “having” are intended to be inclusive and mean that there may be additional elements other than the listed elements. Furthermore, any numerical examples in the following discussion are intended to be non-limiting, and thus additional numerical values, ranges, and percentages are within the scope of the disclosed embodiments.

Reference throughout the specification to “examples, “in examples,” “with examples,” “various embodiments,” “with embodiments,” “in embodiments,” or “an embodiment,” or the like, means that a particular feature, structure, or characteristic described in connection with the example/embodiment is included in at least one embodiment. Thus, appearances of the phrases “examples, “in examples,” “with examples,” “in various embodiments,” “with embodiments,” “in embodiments,” or “an embodiment,” or the like, in places throughout the specification are not necessarily all referring to the same embodiment. Furthermore, the particular features, structures, or characteristics may be combined in any suitable manner in one or more examples/embodiments. Thus, the particular features, structures, or characteristics illustrated or described in connection with one embodiment/example may be combined, in whole or in part, with the features, structures, functions, and/or characteristics of one or more other embodiments/examples without limitation given that such combination is not illogical or non-functional. Moreover, many modifications may be made to adapt a particular situation or material to the teachings of the present disclosure without departing from the scope thereof.

All matter contained in the above description or shown in the accompanying drawings shall be interpreted as illustrative only and not limiting. Changes in detail or structure may be made without departing from the present disclosure.

While the disclosed materials have been described in detail in connection with only a limited number of embodiments, it should be readily understood that the embodiments are not limited to such disclosed embodiments. Rather, the disclosure can be modified to incorporate any number of variations, alterations, substitutions, or equivalent arrangements not heretofore described, but which are commensurate with the spirit and scope of the disclosed materials. Additionally, while various embodiments have been described, it is to be understood that disclosed aspects may include only some of the described embodiments. Accordingly, the disclosure is not to be seen as limited by the foregoing description but is only limited by the scope of the appended claims.

All terms used in the claims are intended to be given their broadest reasonable constructions and their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Further, the use of “at least one of” is intended to be inclusive, analogous to the term and/or. As an example, the phrase “at least one of A, B and C” includes A only, B only, C only, or any combination thereof (e.g. AB, AC, BC or ABC). Additionally, use of adjectives such as first, second, etc. should be read to be interchangeable unless a claim recites an explicit limitation to the contrary.

Joinder references (e.g., attached, coupled, connected, and the like) are to be construed broadly and may include intermediate members between a connection of elements, relative movement between elements, direct connections, indirect connections, fixed connections, movable connections, operative connections, indirect contact, and/or direct contact. As such, joinder references do not necessarily imply that two elements are directly connected/coupled and in fixed relation to each other. Connections of electrical components, if any, may include mechanical connections, electrical connections, wired connections, and/or wireless connections, among others. Uses of “e.g.” and “such as” in the specification are to be construed broadly and are used to provide non-limiting examples of embodiments of the disclosure, and the disclosure is not limited to such examples.

While processes, systems, and methods may be described herein in connection with one or more steps in a particular sequence, it should be understood that such methods may be practiced with the steps in a different order, with certain steps performed simultaneously, with additional steps, and/or with certain described steps omitted.

What is claimed:

1. A cementitious composite, comprising:
a cementitious matrix;
aggregates disposed in the cementitious matrix; and
a conductive coating comprising graphene nanoplatelets (GNPs) disposed on surfaces of at least some of the aggregates, the GNPs being deposited on the surfaces of the aggregates prior to combining the aggregates with the cementitious matrix, wherein the GNPs are positioned at an interfacial transition zone between the aggregates and the cementitious matrix.

2. The cementitious composite of claim 1, wherein the conductive coating comprises graphene nanoplatelets (GNPs).

3. The cementitious composite of claim 2, wherein the GNPs form crosslinked nanoplatelet structures at the interfacial transition zone.

4. The cementitious composite of claim 2, wherein the GNPs are provided in an amount of up to about 0.4% by weight of cement.

5. The cementitious composite of claim 1, further comprising macroscale conductive fibers distributed in the cementitious matrix adapted and forming a conductive network bridging the aggregates.

6. A conductive concrete pavement system, comprising:
a cementitious composite including a cementitious matrix and aggregates disposed in the cementitious matrix, wherein a conductive coating is disposed on surfaces of at least some of the aggregates;
first and second electrodes embedded in the cementitious composite and spaced apart from one another;
a power source electrically connected to the first and second electrodes and configured to apply a voltage across the cementitious composite;
wherein the conductive coating comprises graphene nanoplatelets (GNPs) positioned at an interfacial transition zone between the aggregates and the cementitious matrix, and wherein the GNPs form a continuous conductive pathway between the first and second electrodes through GNP-shell-to-GNP-shell contact between adjacent coated aggregates.

7. The conductive concrete pavement system of claim 6, further comprising an electrical insulation layer disposed beneath the cementitious composite.

8. The conductive concrete pavement system of claim 6, further comprising a plurality of thermocouples arranged in the cementitious composite.

9. The conductive concrete pavement system of claim 6, further comprising a controller operatively connected to the power source for controlling energy consumption.

10. The conductive concrete pavement system of claim 6, further comprising macroscale carbon fibers distributed in the cementitious matrix that form a conductive network bridging the aggregates.

11. A method of preparing conductively coated aggregates, comprising:
washing aggregates and drying the aggregates to remove surface moisture and contaminants;
preparing an aqueous dispersion of graphene nanoplatelets (GNPs);
applying the GNPs to surfaces of the aggregates; and
drying the aggregates to obtain conductively coated aggregates.

12. The method of claim 11, wherein applying the GNPs comprises immersing the aggregates in the aqueous dispersion to adsorb the GNPs onto the surfaces of the aggregates.

13. The method of claim 12, wherein the immersing is performed for a duration of about 30 minutes.

14. The method of claim 12, wherein drying the aggregates comprises oven-drying at about 60 °C to about 80 °C.

15. The method of claim 11, wherein applying the GNPs comprises:
adding a cement slurry to the aqueous dispersion to form a cement-GNP slurry; and
spraying the cement-GNP slurry onto the aggregates.

16. The method of claim 15, wherein the spraying is performed while the aggregates are placed on a heated surface maintained at a temperature of about 60 °C.

17. The method of claim 15, wherein the cement slurry is added to the aqueous dispersion at a ratio of about 5 grams per 100 cm³ of aqueous dispersion.

18. The method of claim 11, wherein applying the GNPs comprises:
immersing the aggregates in a hydrated lime slurry and drying the aggregates to form lime-treated aggregates; and
spraying the aqueous dispersion onto the lime-treated aggregates.

19. The method of claim 18, wherein the spraying is performed while the lime-treated aggregates are placed on a heated surface maintained at a temperature of about 60 °C until fully dried.

20. The method of claim 11, wherein the GNPs are provided in an amount of up to about 0.4% by weight of cement.
